(19) United States
(12) Patent Application Publication
(10) Pub. No.: US 2011/0320395 A1
(43) Pub. Date: Dec. 29, 2011

(54) Optimization of Multi-channel Commerce

(76) Inventors: Uzair Dada, San Ramon, CA (US); Jason Kobilka, Mountain View, CA (US); Michael Krol, Beaverton, OR (US); Adeeb Ashraf, San Ramon, CA (US); Abe Mammen, Pleasanton, CA (US); Omer Saeed, Lahore (PK)

(21) Appl. No.: 12/826,637

(22) Filed: Jun. 29, 2010

(51) Int. Cl. G06F 17/30; G06N 5/02; G06F 15/16; G06F 3/048

(52) U.S. Cl. 706/47; 715/702; 715/738; 707/740; 707/709; 707/E17.046; 707/E17.108

(57) ABSTRACT

Content provided by a decision engine system is described. Content, stored in a server system, is provided to a plurality of display units at a plurality of touch point devices. One or more features are determined to optimize the content provided to the plurality of display units. The content is updated syndicated across the plurality of display units at the plurality of touch point devices based on the determination.

### TECHNICAL FIELD

The disclosed embodiments relate to digital computing or data processing systems and methods in commerce, and in particular an integrated marketing platform for multi-channel commerce systems.

### BACKGROUND

Electronic commerce consists of the buying and selling of products or services over electronic systems such as the Internet and other computer networks. The amount of trade conducted electronically has grown extraordinarily with widespread Internet usage. The development of the world-wide web and the proliferation of Internet-based e-commerce have notable expanded the methods of advertising and marketing.

Modern electronic commerce typically uses the World Wide Web at least at some point in the transaction's lifecycle, although it can encompass a wider range of technologies such as displaying advertisements on e-mail, text messages, at electronic kiosks, mobile devices and other electronic media sources.

Electronic content, such as display banner ads, pop-up ads, and other electronic advertisement, are typically displayed as multiple strains of static content at multiple websites. Updating these content units is achieved statically not dynamically. In other words, the content units cannot be updated or interchanged in real-time. The updates to the content must occur at the source location in order for such changes to appear at the various sites in which the content is displayed. Management of such static content requires a conscious mining of information based on changes to the content and actions or decisions by the content-provider. For example, if the price of a consumer product changes, if the products are sold out, or if the SKU number change, and so on, the updates must be manually made to the advertisement units at the one or more source locations before the updates are reflected at the various target sites.

Therefore, there is a need for updating or optimizing multiple strains of electronic content dynamically and in real-time from a centralized location.

### BRIEF DESCRIPTION OF THE DRAWINGS

For a better understanding of the aforementioned embodiments of the invention as well as additional embodiments thereof, reference should be made to the description of embodiments below, in conjunction with the following drawings in which like reference numerals refer to corresponding parts throughout the figures.

FIG. 1 is a block diagram of an Engage Engine system, according to some embodiments.

FIG. 2 is a block diagram of a network system that includes an Engage Engine system, according to some other embodiments.

FIG. 3 is a block diagram of a network system that includes an Engage Engine system, according to some other embodiments.

FIG. 4 are screenshots illustrating two instances of an EE product, according to some embodiments.

FIG. 5 is a flow chart illustrating an operation of the Engage Engine of FIG>3, according to some embodiments.

FIG. 6 is a block diagram representing an Engage Engine platform, according to some embodiments.

FIGS. 7A-7F are various diagrams illustrating elements and operations of a Catalog Manager system of FIG. 3, according to some embodiments.

FIGS. 8A-8C are various diagrams illustrating elements and operations of a Customer Interaction Engine of FIG. 3, according to some embodiments.

FIGS. 9A-9C are various diagrams illustrating elements and operations of a Business Intelligence system and Customer Interaction Engine of FIG. 3, according to some embodiments.

FIGS. 10A-10E are various diagrams illustrating elements and operations of a Content Management System of FIG. 3, according to some embodiments.

FIG. 11 is a block diagram of various ways in which content may be displayed in templates managed by the Content Management System of FIG. 3, according to some other embodiments.

FIGS. 12A-12B a block diagram and flow diagram illustrating a Recommendation Engine system of FIG. 3, according to some embodiments.

FIGS. 13A-13B are diagrams illustrating a virtualized queuing system, according to some embodiments.

FIGS. 14A-14E are screenshot examples of various Engage Engine products, according to some embodiments.

FIG. 15 is a block diagram illustrating a server system that includes an Engage Engine system, according some to embodiments.

FIG. 16 is a flow diagram of a method of providing content by a decision engine system, according to some embodiments.

FIG. 17 is a flow diagram of a method of providing content by a decision engine system, according to some other embodiments.

FIG. 18 is a flow diagram of a method for a virtualized queuing process of traceable links, according to some embodiments.

FIG. 19 is a flow diagram of a method for a virtualized queuing process of traceable links, according to some other embodiments.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known methods, procedures, components, and circuits have not been described in detail so as not to unnecessarily obscure aspects of the embodiments.

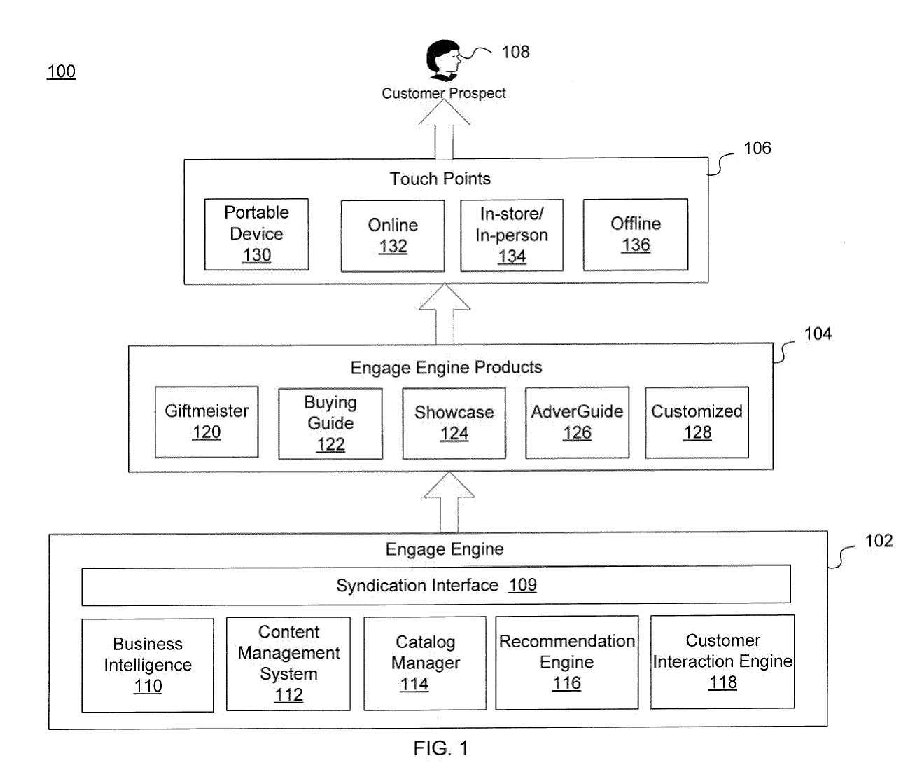

FIG. 1 illustrates a system 100 in which the Engage Engine 102 provides a platform for providing various Engage Engine products and services (“EE products”) 104 accessed by multiple touch points 106, according to some embodiments. The EE products 104 include a collection of products and services available to subscribers to the Engage Engine 102 for serving content to their customers and customer prospects in a multitude of engaging ways. EE products 104 include on-demand software products that are rich media eCommerce-enabled applications that may be placed anywhere the subscriber's customer prospects accesses any purchasing path, details of which will be further described. The EE products 104 are viewed or accessed by a customer prospect 108 via one of many touch points 106.

It will be appreciated that customer prospects 108 include customers or clients to a business, potential customer prospects, general consumers, and any visitor or user, for example at a website or other interface/browser, who may engage in or have the potential to engage in any purchasing path and who has access to any touch point 106, hereinafter “customer prospects.” EE products, such as EE products 104, means any product or service provided by or serviced by the Engage Engine 102, including services to manage and update content at any site networked or otherwise. Consumer products include any item, product or object that has an actual SKU associated with it and that may be the subject of any displayed content in the EE products and/or may be advertised to or purchased by a customer prospect. Consumer products additionally include services that may be advertised or purchased by customer prospects, such as online courses, but that may or may not have an SKU identifier.

The Engage Engine 102 monitors and dynamically updates content displayed at multiple sites over a network. The Engage Engine 102 provides a platform that allows for intricately serving up content that is highly engaging to the subscriber. The Engage Engine 102 achieves this in a number of ways. It allows monitoring and dynamically updating content to different EE products, across multiple sites through multiple touch points 106. Additionally, the Engage Engine 102 has the ability to learn about the different user interfaces to optimize site visitor's engagement across any of the touch points 106. In some embodiments, the Engage Engine 102 utilizes these insights to provide reports to subscribers, permitted third parties or others of interest. In some embodiments, the Engage Engine 102 utilizes the information to learn about the applications it services, such as the various EE products 104, or interactions with the content to service the applications or content sites in a particularized or customized way. Large-scale dynamic updating and information gathering also enables the Engage Engine 102 to methodically optimize system intelligence, in particular around the purchasing paths of the EE products 104.

In some embodiments, the Engage Engine 102 is comprised of at least five sub-components: Business intelligence 110 (“BI”), Content Management System 112 (“CMS”), Catalog Manager 114, Recommendation Engine 116, and Customer Interaction Engine 118 (“CIE”). The CMS 112 maintains EE products for selection by the subscriber to create content and publish it out to selected site locations. The Catalog Manager 114 is a facility for storing and gathering consumer product information and the content associated with consumer products. The CIE 118 tracks the actions and decisions of visitors who interact with particular EE products 104 or the content of the EE products 104. The CIE 118 may additionally collect any information based on the interactions of a consumer prospect, e.g. user segmentation, at any website or interface serviced by the Engage Engine 102. The BI 110 synthesizes the information gathered by the CIE, such as the user segmentation, to create analytics of consumer interactions with EE products. The Recommendation Engine 116 provides a set of rules or allows subscribers to customize a set of rules for generating various recommendations about EE product features, services and content being displayed.

The Engage Engine 102 further includes a syndication interface 109, which syndicates the various services of the engage engine 102 subcomponents across multiple EE products 104 and at multiple touch points 106. The engage engine 104 combines all its subcomponents to syndicate various EE product services using several purchasing paths across multiple sites, and to serve up content in an intelligent, engaging manner through various touch points 106. The syndication interface 109 allows for a seamless delivery of the combined services.

The Engage Engine 109 powers the EE products 104 and various product services associated with each of the EE products 104. In some embodiments, the EE products 104 are stored and managed in the CMS 112, and allows for content to be created and published there. In some embodiments, each EE product 104 is a loadable template in which the subscriber may optionally turn features on and off. The templates may be standardized, and comes in various sizes with certain features that are configurable within them. In some embodiments, the templates may be customized, created based on the particular needs and preferences of the subscriber. The Engage Engine 102, in providing the EE product services and content, also monitors the content to diagnose relevance, perform updates, optimize performance, and gather insight into how customer prospects are engaging in the content.

In some embodiments, EE products 104 include, but are not limited to, the following: Giftmeister 120, Buying Guide 122, Showcase 124, and AdverGuide 126. A number of these EE products 104 provide for an interactive and self-guided interface that simplifies the consumer prospect's decision process. The EE products 104 additionally include features that drive preferences, actions, and behavior insights of one or more consumer prospects across a multi-channel network. In some embodiments, one or more EE products 104 may be a branded product, designed by and provided under the brand name of the service provider of the Engage Engine 102 to its subscribers. For example, the Giftmeister 120 is a branded product that allows customer prospects find gifts for themselves or for others, and create shopping lists or wish lists to share with friends and family. In some embodiments, one or more EE products 104 may be a white labeled product that is produced by the service providers of the Engage Engine 102 which allow the subscriber to rebrand and make the EE product 104 appear as if the subscriber created it. For example, the Buying Guide 122 may be a white labeled product that helps connect consumers with the right consumer products and/or services for themselves, based on their specific needs. The Buying Guide 122 uses an easy-to-use, guided interface for assessing the consumer's requirements, and then providing consumer product recommendations. The Showcase 124 is another EE product that may be either a branded or white labeled product that provides informative content and resources for various consumer products and their features, facilitating customer prospects make informed purchasing decisions. Similarly the AdverGuide 126 is another EE product 104 that may be white labeled or branded, and is an interactive ad unit allowing consumers to answer questions about their consumer product needs, and in return recommends consumer products to them, within the ad unit on any site on the network. Included in the offered EE products 104 may be a customized template 128, which may be designed for the particular needs of the subscriber when, for example, none of the other EE products 104 meet the particular needs of the subscriber.

The Engage Engine 102 syndicates its EE products 104 across N sites that are accessed from any number of touch points 106. Thus, multiple EE products 104 or content at multiple sites may be syndicated from a centralized location to simultaneously and instantaneously or in real-time to update or improve the content across N sites. Furthermore, all of the EE products 104 can be embedded anywhere where the customer prospect is located. The syndication feature of the Engage Engine 102 provides the desired information, optimizes the information after it has been uploaded, and continually gathers insights to how the information is engaged in any application provided through the EE products 104 across one or more different touch points 106 in a holistic way. The Engage Engine 102 additionally has the capability to make recommendations and optimize functionality across multiple sites, but do so independently for each site. In other words, the optimization, recommendation, updates, and so on for one site may be unique to each site or different, but syndication is achieved across the multiple sites.

The touch points 106 may be any device or medium that allows access of content through instances of EE products 104, for example, content that may reside in instances of the EE products 104. In some embodiments, touch points 130 include portable devices 130, which may be any device including, but not limited to, mobile phones, smart phones, PDAs, laptop computers, hand-held touch screen devices, tablets, netbooks, mobile internet devices (MIDs), e-readers, and so on, in which content may be displayed. In some embodiments, touch points 106 include online sites 132, such as webpage, images, video or any piece of content that may be viewed through a web browser in private and public networks, having a Uniform Resource Location (URL), or any web address. In the advertising and marketing space, online sites 132 include sites where content may be accessed on search engine results pages, banner ads, rich media ads, social networking sites, online advertising, interstitial ads, online classified advertising, advertising networks and e-mail marketing, including e-mail spam. In some embodiments, in-store/in-person touch points 134 may include in-store kiosks, electronic display screens, advertisement windows, displays at tradeshows, screens and monitors displayed in-store, electronic point-of-sale, and so on, any of which may be network connected or wirelessly connected. Offline 136 touch points refer to any device, including in-store devices (e.g. tablets, kiosks, widgets) that are not networked but may be manually uploaded by, for example, downloading updates from the Engage Engine 102 onto an external memory device and uploading it onto the touch point device. These include EE product templates that do not need to be connected to the network. However, offline touch points 136 could be optionally connected online (i.e., from time to time), and configured to automatically synchronize with the Engage Engine 102.

It will be appreciated that subscriber refers to subscribers to the EE products 104 serviced by the Engage Engine 102; users who can create or provide content to instances of the EE products 104; users with authorization or limited permission to access EE products 104, make decisions about content or update content in EE products 104; and users authorized to engage with the EE products 104 in a particular manner.

An example of a subscriber may be a marketer of a company, corporation, small business or individual desiring to advertise or market one or more consumer products or a catalog of products that may be serviced by the Engage Engine 102. Thus, marketers may utilize the Engage Engine 102 platform to deliver any one of the EE products 102, including their own customized products 128, such as buying guides, personalized stores, branded products, and other dynamic content-based units with embedded decision and recommendation features. These product features may be syndicated across a broad variety of audience touch points 106, including marketers' own websites, sites of their marketing or channel partners, social networks, advertising networks, email, mobile devices, e-readers and in-store displays, as previously described. The Engage Engine 102 platform brings all or a subset of these features of the purchasing experience directly to the consumer prospects wherever they are on the digital landscape.

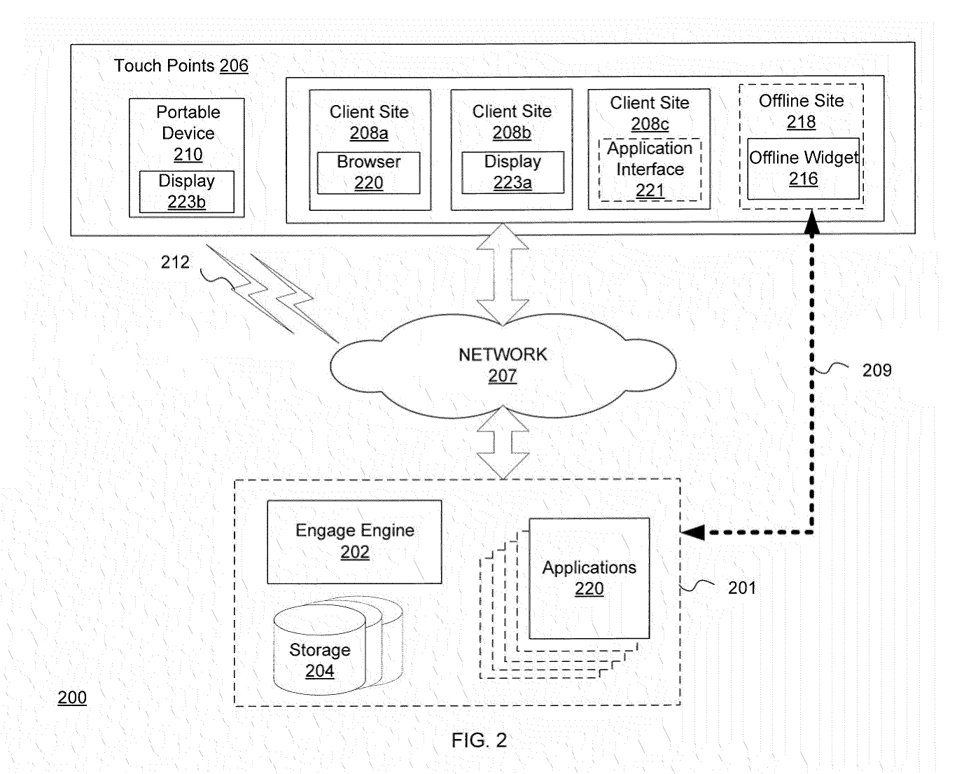

FIG. 2 illustrates a network system 200 having an Engage Engine system 201 according to some embodiments. The Engage Engine system 201 includes an Engage Engine component 202, storage 204, and a plurality of applications 220 managed by the Engage Engine 202. The Engage Engine 202 provides content or updates content in applications 220 from a centralized location that are displayed across multiple touch points 206 at one or more various sites. In some embodiments the Engage Engine 202 may rely on storage system 204 that may be internal to the overall Engage Engine system 201, where the Engage Engine 202 and the storage system 204 are part of the same system. In some embodiments, the Engage Engine 202 may rely on storage system 204 that is located external to the Engage Engine 202. In some embodiments the Engage Engine 202 may utilize a combination of internal and external storage resources collectively represented by storage 204.

The network system 200 works especially well for large advertising strains across multiple networks, shown generically as network 207. The Engage Engine 202 communicates with multiple client sites 208 that display applications 220 which allow consumer prospects 108 to engage in or interact with content of applications 220. Client sites 208 may be any type of client known in the art, including but not limited to laptop computers, hand-held touch screen devices, tablets, netbooks, and other display devices. The applications 220 serviced by the Engage Engine 202 may be provided to the various sites via a web browser 220, some application interface 221, or any display component 223a of the client 208.

Touch points 206 additionally include an offline site 218, may be located in-store, at an event site, or accessed by a customer prospect in-person. The offline site 218 includes an offline widget 216 that provides content to the customer prospect to allow the customer prospect to view and interact with content. Offline site 218 may be an in-store kiosk or any computing device capable of displaying electronic content in offline widget 216.

The offline widget 216 may be updated periodically by a service provider or by the in-store subscriber. For example, the offline widget 216 may be updated from a USB memory device downloaded and the content may be updated manually in-store 209. In some embodiments, the offline widget 216 may be updated wirelessly. In some embodiments, the offline site 218 may be serviced by the network 207 via an internet connection linked directly to the offline site 218.

The Engage Engine 202 provides applications 220a-220c to the client sites 208 via some application interface 221, web browser 220, or some display 223a, as previously described, which allow customer prospects to the site to engage or interact with the contents of the application 220. Applications 220 may be any of the EE products 104, instances of the EE products 104, or any other software medium that allows the Engage Engine 202 to provide and service content. Client sites 208a-208c may be any website accessed via network 207 capable of displaying the content. In some embodiments, content may be a form of promotion for the purpose of delivering marketing messages to attract customer prospects. Examples include, but are not limited to, contextual ads on search engine results pages, banner ads, rich media units, social network advertising, interstitial ads, online classified advertising, advertising networks, and e-mail marketing, including e-mail spam. Content may additionally include a widget or ad unit that constitutes a promotion or display of a consumer product, a rich media unit, ad unit, flash-based media advertising, banners, or any content in an internet browser that presents a consumer product offered to the customer prospect. The content may be of any type content, including text, image, video, audio or any combination of electronic media. Content also includes interactive elements, such as search and browse capabilities, or links to other websites, such as to other instances of EE products 104.

In some embodiments, the applications 220, are displayed by an application interface 221 which may allow users to further interact with the content of the applications 220, for example, to respond to surveys, post reviews, check reviews by others, link to the EE product site, and so on. As will be described in detail, these interfaces 221 additionally send application usage data (e.g., analytics) back to the Engage Engine 202 for further processing. In some embodiments, an application 220 is embedded in an instance of an EE product 104 that the Engage Engine 202 specifically services.

In some embodiments, the engage engine 202 may communicate wirelessly 212 from the network 207 to a touch point that consists of a portable device 210 capable of displaying an application 220 that is serviced by the Engage Engine 202. Portable devices may include, but are not limited to, mobile phones, smart phones, PDAs, laptop computers, hand-held touch screen devices such as tablets, netbooks, mobile Internet devices (MIDs), e-readers and so on, in which an advertisement, rich media, widgets or other electronic content may be displayed.

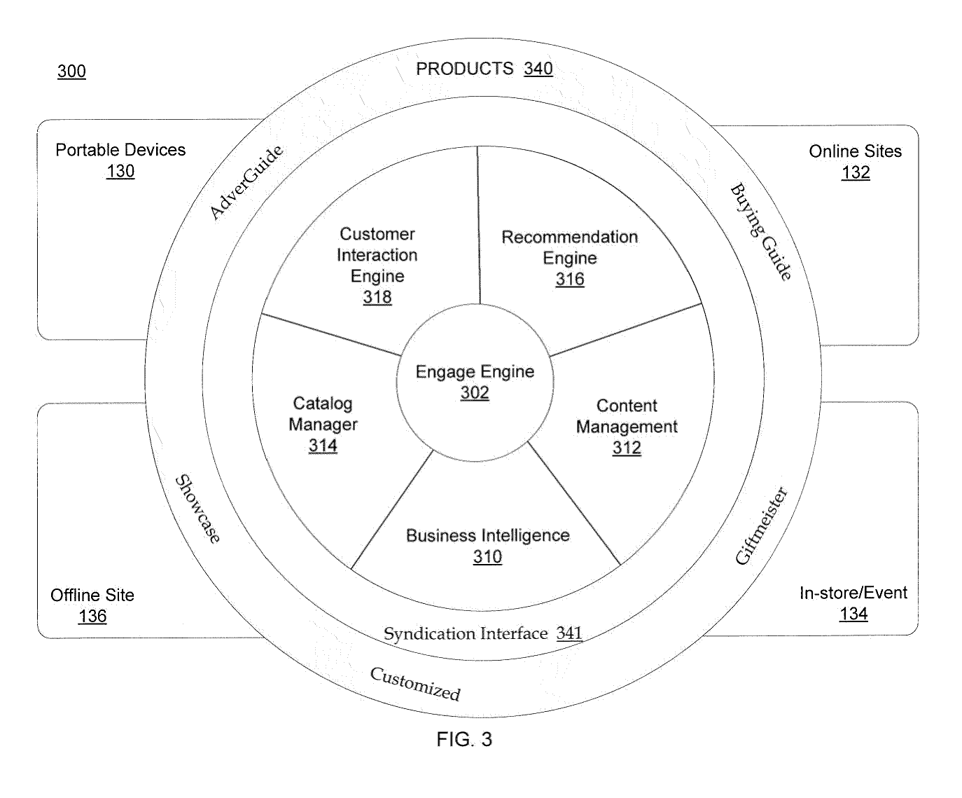

FIG. 3 is another illustration of the Engage Engine system 300 according to some other embodiments. The system 300 shows the workings of the Engage Engine 302 as a functionally holistic system in which its subcomponents are intricately connected. As previously described, the Engage Engine 302 comprises at least five components: BI 310, CMS 312, Catalog Manager 314, Recommendation Engine 316, and Customer Interaction Engine 318. The Engage Engine 302 interfaces with EE products 340 at multiple locations via a syndication interface 341. EE products 340 include, but are not limited to, the Giftmeister, Buying Guide, AdverGuide, Showcase, and other customized EE products as previously described.

More specifically, through the Engage Engine 302 the subscriber may manage the content of EE products 340 and receive qualified feedback on any of the subscriber's content at any time and anywhere. In some embodiments, the featured EE products 340 of the system 300 reside in and are managed by the CMS 312, in which the subscriber may select a particular EE product 340 and specify particular features of the EE product. In some embodiments, the CMS 312 includes flexible template-based skins with a customizable interface for ease of use by the subscriber. The user interface may include customizable components which the subscriber can enable or disable features.

In some embodiments, the CMS 312 is automated to monitor and manage content on a continual basis. The CMS 312 may additionally consult any other subcomponent to receive qualified leads on the content. For example, the Catalog Manager 314 may indicate that the content was recently updated, such as on consumer product availability, pricing changes, SKU changes, and so on. In another example, the Recommendation Engine 316 and BI 310 may have additional information about how consumers react to or interact with the particular content, prompting the CMS 312 to modify the content based on the insights provided by the Recommendation Engine 316 and/or BI 310. In some embodiments, the CMS 312 provides customizable alerts and notifications to the subscriber of any of the updates and insights to the content.

In some embodiments, the Catalog Manager 314 stores and maintains any content utilized by the Engage Engine 302 or in any of its EE products and services. The Catalog Manager 314 acquires data from a number of different sources. Through built-in scrapers, the Catalog Manager 314 includes a number of automated features to crawl targeted web sites, web sites through third party Application Programming Interfaces (API), data feeds and so on to update its database. For example, the Catalog Manager 314 constantly gathers information about various objects (e.g., consumer products) for accurate and up-to-date information on the content of the EE products 340, such as, in the case of advertisements, pricing information, promotions, stock, and so on. The Catalog Manager 314 may additionally collect data through manual and imported data feeds. In some embodiments, data is assembled, validated, parsed, and categorized in the Catalog Manager 314, to prepare the collected data for further analysis by one or more of the other subcomponents of the Engage Engine 302. Thus, the content is always being updated and processed, providing all the other subcomponents of the Engage Engine 302 with live, most up-to-date data that may be further utilized to update content served up at EE product sites or to optimize any content being displayed through the Engage Engine 302.

The CIE 318 tracks the actions and decisions of visitors to the EE product sites. Various types of data are gathered based on the interaction of customer prospects. Information such as popularity of consumer products, preferences of certain attributes, use of particular services, attributes of the customer prospects to the site, and so on become valuable in identifying the type of customer prospect to the particular site, describing the preferences of customer prospects or an individual visitor, and identifying trends or patterns. For example, if features such as personalized URLs, click-to-talk or click-to-chat links, and other relevant content/offers/services are included in the EE product page 340, the number of clicks to each of the various features may be tracked. In another example, the CIE 318 may track the type of customer prospect or the preferences of particular customer prospects in certain geographic locations. In some embodiments, the information tracked by the CIE 318 may be packaged for third party systems. The CIE 318 additionally incorporates information about specific customer prospects, and their previous interactions and preferences within the system, to also analyze that information against information collected on other customer prospects, and incorporates the collective analysis into the Engage Engine 302. Therefore, the Engage Engine 302 has current and updatable information about trends and predictive actions of a category, group or type of customer prospects. For example, the Engage Engine 302 has data on how a specific customer prospect has behaved or acted, trends across multiple customer prospects, seasonal preferences of customer prospects according to group-type, culture, location and so on. In some embodiments, the information tracked by the CIE 318 may be packaged for third party systems.

In some embodiments, the CIE 318 assigns weights to particular interactions. The weights may be determined based on the particular interests of subscribers about their customer prospects or in emphasizing or deemphasizing some interest. It will be appreciated that any traceable metrics known in the art may be utilized. In some embodiments, pattern recognition mechanisms may also be utilized such as in social networking patterns. For example, customer prospects may be categorized into gender, age group, location, and so on. Their preferences (consumer product type, brand, or other criteria) may be associated with their profile based on their interactions with different EE products 340 on Engage Engine 302 platform using various algorithms and rules that apply weights to or identify patterns based on their profiles or preferences.

Information that is gathered by the CIE 318 and the Catalog Manager 314 are used by the CIE 318 for synthesis and by the BI 310 in creating analytics and reports for the subscriber. Information such as traffic, frequency of clicks, visitor engagements, and purchasing behavior insights may be extracted into analytics that can be synthesized by the CIE 318 and put into reports by the BI 310. The BI 310 is capable of reporting analytics comparisons from multiple properties to identify trends based on particular information such as segment, geography, attributes of visitors, and so on. The CIE 318, along with the reports by the BI 310, additionally provides insights into visits, engagement and conversion for various applications running on Engage Engine 302 platform, so that subscribers of the Engage Engine 302 may make informed decisions about how to serve up their content, such as how to best market and sell their consumer products. The CIE 318 also integrates with the optimization features of other realms in the Engage Engine 302, and uses these metrics and usage data to dynamically display the highest performing content.

The Recommendation Engine 316 is a rules-based configuration system that allows subscribers to make recommendations for optimizing or modifying EE products 340 and any content embedded in the EE products 340. The Recommendation Engine 316 works with other parts of the Engage Engine 302, such as the Catalog Manager 314, BI 310 and CIE 318 to apply its rules and structures to generate relevant decision criteria to provide specific, targeted and accurate consumer product or content recommendations. In some embodiments, the recommendations are generated automatically to initiate automatic updates to the EE products 340. However, manual updates are also possible. In some embodiments, the Recommendation Engine 316 may provide recommended rules and preferences, while in other embodiments the rules and preferences may be customized or manually defined by the subscriber.

It will be noted that the various features of the Engage Engine 302 allow for microsegmentation and micro-targeting of EE products 340 and its content. Microsegmentation uses technology and techniques, such as data mining, artificial intelligence, pattern recognition and pattern extrapolation and algorithms, to recognize and predict minute consumer purchasing and behavioral patterns. The collected information may be used to identify precise microsegments (down to the individual consumer/visitor level). Microsegments can then be the focus of personalizing the content within the EE products 340. Such information can also be used in micro-targeting to a type of potential visitor or group of visitors to the EE product site 340.

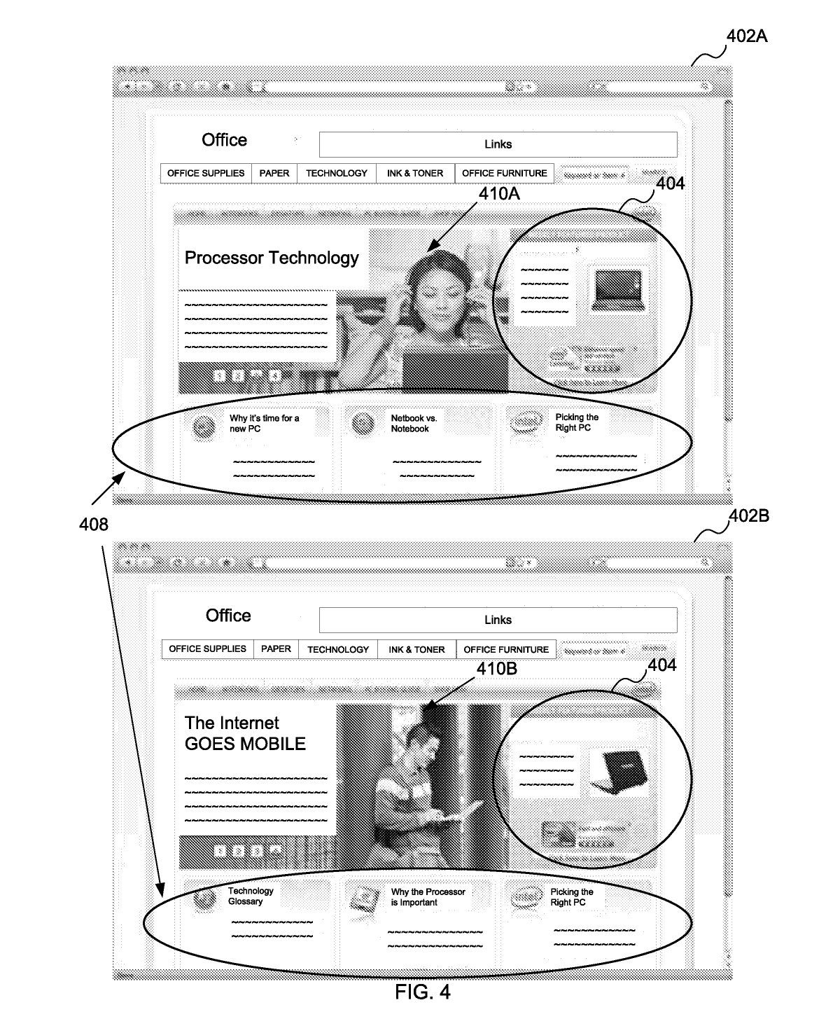

FIG. 4 illustrates two instances of an EE product template 402 for advertising a laptop computer as a featured product 404 for different types of customer prospects. In illustrating a basic operation of the Engage Engine 302, the EE product template 402 may be displayed at multiple web sites over a network. If a newer version of the laptop computer advertised in instances 402A and 402B becomes available, the Catalog Manager 314 will have recognized the newer consumer product from its database. The Recommendation Engine 316, in determining that the newer laptop may be preferred based on its rules configuration or profiling of the particular customer prospect, may recommend the newer laptop to be displayed. Alternatively, the Recommendation engine 316 may have different preference histories for the customer prospect at instance 402A than the customer prospect at instance 402B. In such case, the laptop displayed in instance 402A will be different from the laptop displayed in instance 402B. The Content Management 312 may automatically and simultaneously provide the relevant consumer product multiple instances, such as 402A and 402B, or multiple EE products 340 across all sites. The entire process is automated as soon as updated preferences are detected or new/updated consumer product information becomes available.

Through microsegmentation, the CIE 318 has the further capability of tracking the preferences of individual customer prospects or certain class of customer prospects to each respective instance of the EE product template 402. Thus, the Engage Engine 302 is capable of providing variations in the content displayed in the instances of the EE product template 402 depending on preferences of individual prospects or class of prospects. For example, at an individual customer prospect's level, such as within a social networking account, the respective instance of the EE product site 402 display of the featured product 404 may be different for a first prospect, e.g. at instance 402A than a second prospect, e.g., at instance 402B, while at the same social networking site.

Suppose that the CIE 318 has detected a trend in the popularity of one particular laptop over another for a particular customer prospect or class of customer prospects. Depending on the CIE 318 analysis of customer information and/or rules of the Recommendation engine 316, the featured laptop 404 may be upgraded to display a consumer product with customized features 408 that are different for different instances 402A and 402B. This process is again automated by the Engage Engine 302 as soon as the information becomes available to the CIE 318 and Recommendation Engine 316. The subscriber is not required to know that new laptops become available or that one customer prospect or class of customer prospects prefers certain laptop features over another customer prospect or class. Furthermore, the upgrade is simultaneously applied to all or select locations of instances of the EE product template 402.

In some embodiments, other background content displayed in the instances of the EE product template 402 may be different and customized for the customer prospect at that particular instance 402. For example, in the instance 402A, the customized product information may be directed towards a female customer prospect 410 based on CIE's 318 determination of trends of females of a particular age and/or at a particular geographic location. Thus instance 402A displays a female of college age to feature that particular laptop. Conversely, the customer prospects viewing instance 402B may be popular among young male professionals, according to the Engage Engine 302. In such case, instance 402A displays a young professional-looking male 410B to feature the particular laptop in instance 402B. Thus, across multiple sites, different variations of the EE product template 402 may be provided, displaying variations in the content based upon the findings of the Engage Engine 302. Additionally, the variations of content may be simultaneously updated and optimized as additional information is collected by the Engage Engine 302.

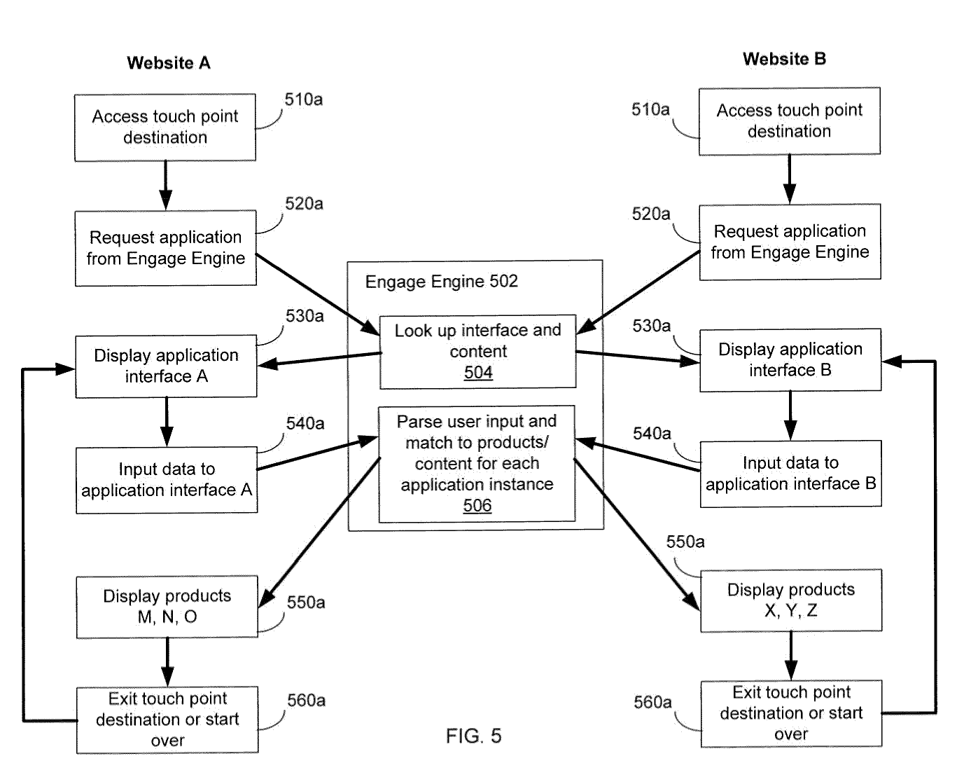

FIG. 5 is a flow chart that further describes the operation of the Engage Engine 102, 302 facilitating multiple locations according to other embodiments. In this example, two visitors access an external touch point destination 510 at two different locations A and B. The external touch point destination may be a website, a kiosk in-store, an application through a web browser, and so on. Each visitor makes a request for an application through the external touch point destination at step 520. In some embodiments, the request is made by including identifier information such as, but not limited to, a unique identifier for the application type, business identifier, language, campaign, and so on. A campaign may refer to any arbitrary identifier for a discrete time period, usually referring to purchasing seasons such as “holiday 2010.” At step 504, the Engage Engine 502 looks up appropriate interfaces to service the request from one or more of the subcomponents 310-18 and to the content in one or more EE products 340. In some embodiments, the syndication interface 341 does the look up. The Engage Engine 502 returns to the visitor an application interface corresponding to the request at step 530a. In the case of the visitor at Website A, application interface A is displayed and in the case of the visitor at Website B, application interface B is displayed.

At step 540, the visitors interact with the application and inputs data, such as answering questions about their needs. The Engage Engine 502 parses the user input data and matches the input to consumer products and content for each application instance, at step 506. More specifically, the Recommendation Engine 316 likely parses the user input data to match to consumer products and content unique for each application instance. In some embodiments the matching is based on questions and responses by the visitors. In some embodiments the matching is based on previous data stored in cookies, or by IP addresses identified from a previous session. In some embodiments, the receiving and parsing of data may be an automated process that does not require visitors at Websites A and B to consciously input data in response to questions. The Engage Engine 502 may automatically gather data and parse the data from any interaction with application interfaces by visitors at Websites A and B. In some embodiments, the automation is triggered when the identifier information is provided. In some embodiment's, the syndication interface 341 serves the appropriate content to the corresponding interface based on the user's identifier parameters.

The Engage Engine 502 delivers and displays consumer products corresponding to the visitor. For example, consumer products M, N, O are displayed unique to the visitor at website A based on the visitor's input data at step 550a, and consumer products X, Y, Z are displayed to the visitor at Website B based on the visitor's unique input data at step 550b. At step 560, the visitors may exit the touch point destination or start over with another request.

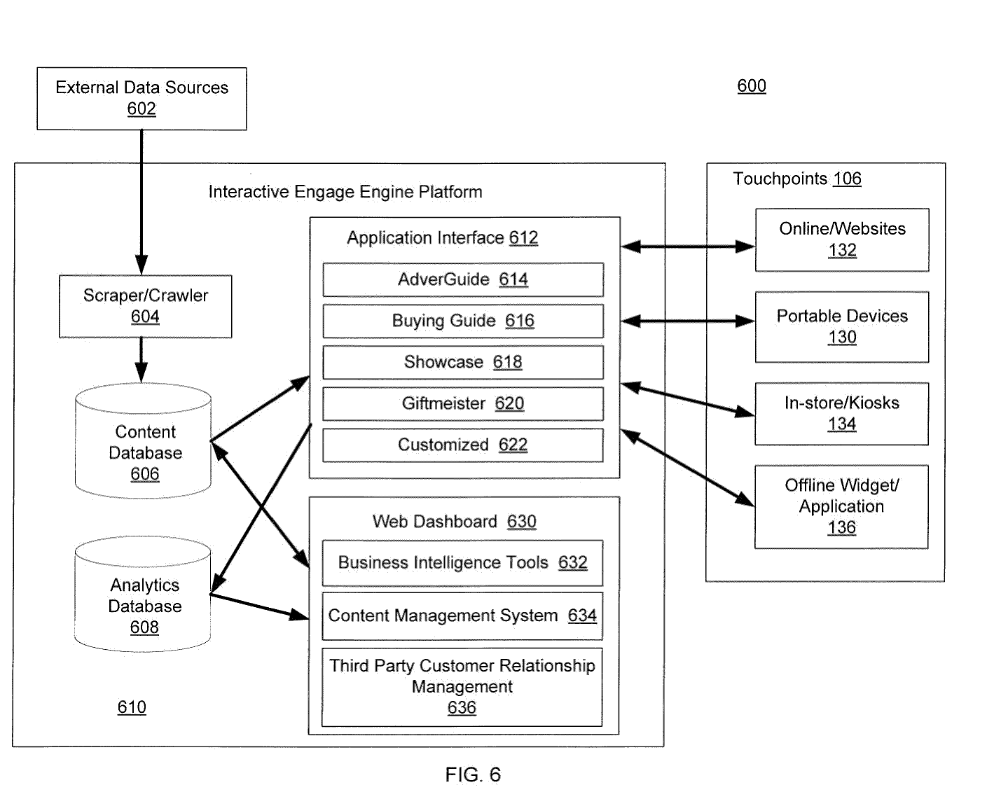

FIG. 6 is a block diagram representing an Engage Engine application platform 610 according to some embodiments. A data scraper or crawler 604 gathers data from any external data source 602 that makes available content relevant to the EE products and services of the Engage Engine 610. The scraper 604 deposits the raw content data to a content database 606. The content data is utilized by one or more set of tools in a web dashboard 630 containing at least the following tools: business intelligence tools 632, content management system interface 634, and other third party CMS integration 636. The web dashboard 630 includes administrative interfaces that allow a subscriber to access backend subcomponent tools of the Engage Engine 302. These administrative interfaces in the web dashboard 630 allows a user to retrieve analytics, e.g., serviced by the BI 310. It will be appreciated that the content database 606 and analytics database 608 may be a single storage unit that may be partitioned. Alternatively, they may be multiple storage units.

The business intelligence tools 632 are a collection of administrative interfaces for analytics that are made available by the BI engine 310. The content management system tools 634 interface with the CMS 312 to provide content and updates to the content to be uploaded onto EE products 340. The content management system tools 634 may additionally be used to manage various customer interactions that may be analyzed by the CIE 318. The third party customer relationship management (“third party CRM”) tool 636 may allow subscribers to interface with third party content providers, tools, and services. The third party CRM 636, in contrast to first party, allows subscribers to incorporate their own tools, such as existing customer relationship management (CRM) tools or eCommerce solutions that they may be using.

Content from the content database 606 may be provided to both the application interfaces 612 and the Web Dashboard 630. The analytics database 608 may receive content from the EE products 340 via the EE product interfaces 614-622 in the application interface 612 to be used by, for example the BI 310, to generate analytics. The analytics may then be accessed by the web dashboard 630 tools. The application interface 612 includes any number of the EE products 340, including an AdverGuide interface 614, Buying Guide interface 616, Showcase interface 618, Giftmeister 620, and other customized interfaces 622. Each of the application interfaces 614-622 correspond to respective EE product templates 340. Through the application interface 612, EE products and applications are loaded onto various touch points 106 as previously described.

Details of each subcomponent of the Engage Engine 302 will now be described.

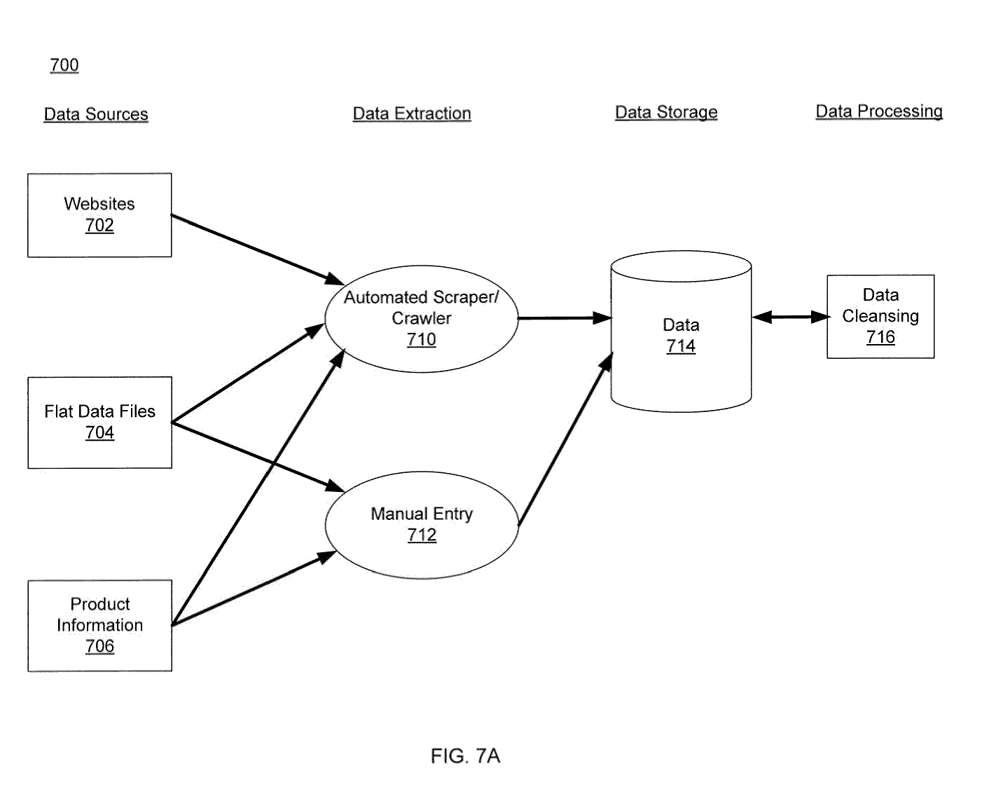

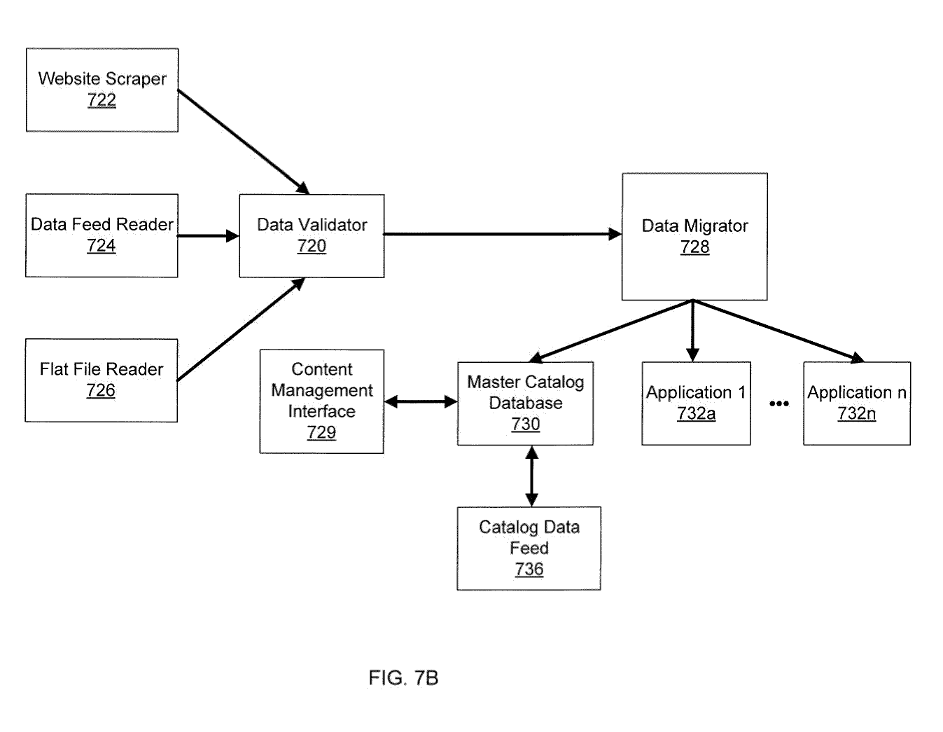

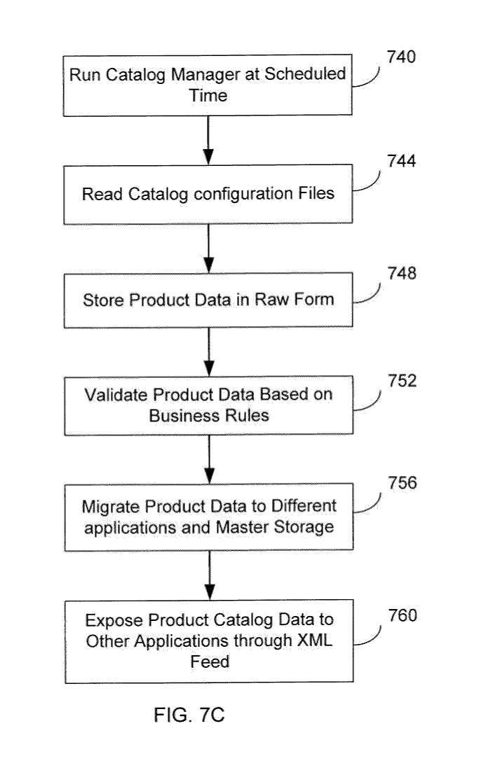

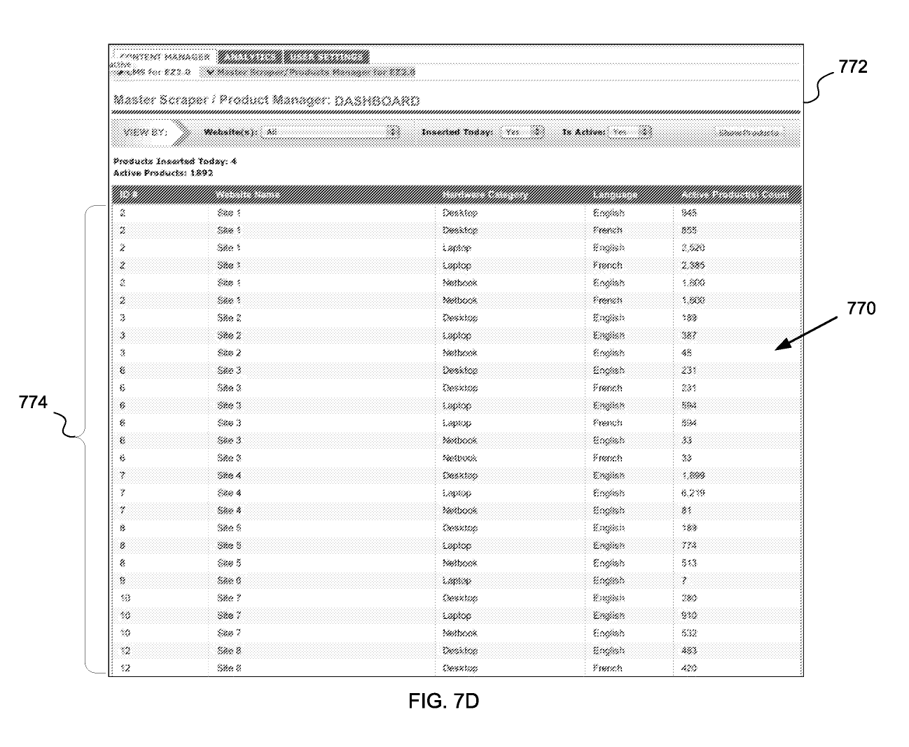

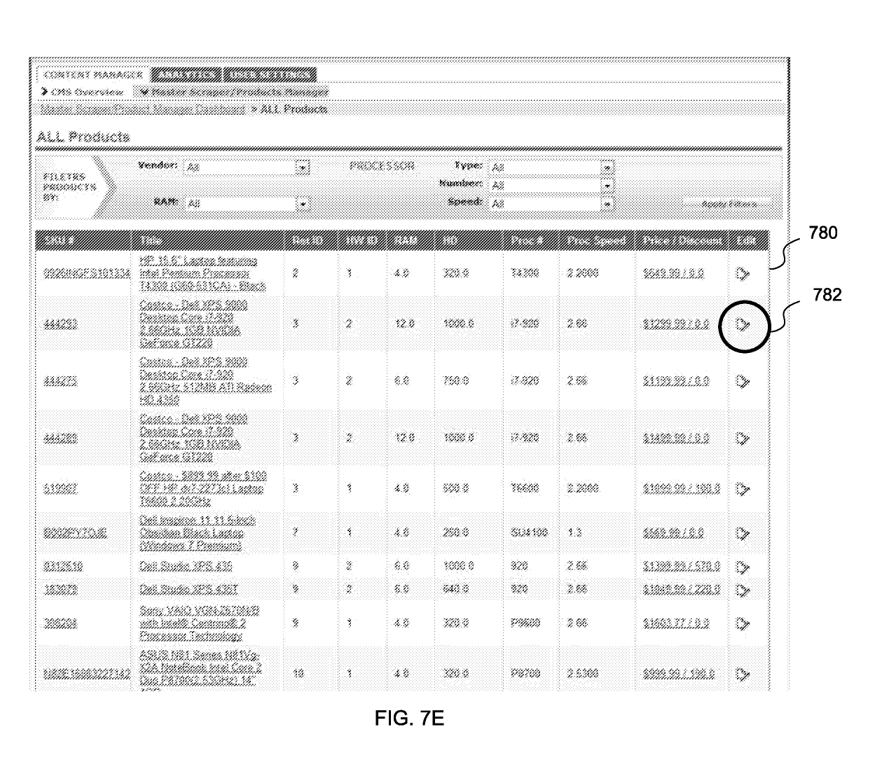

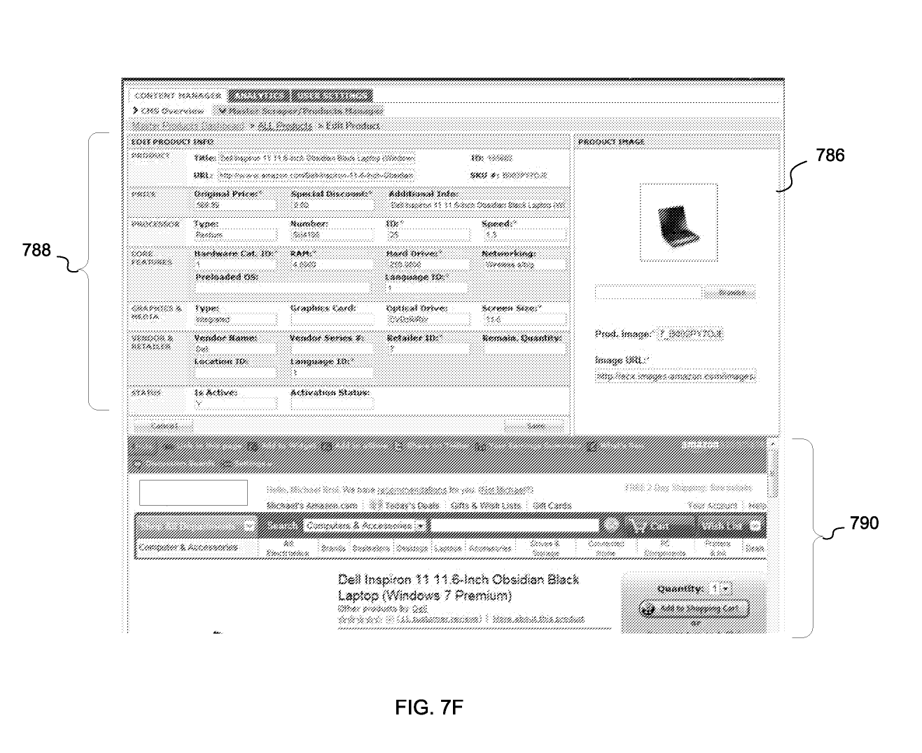

FIG. 7A is a block diagram illustrating the Catalog Manager system 314 of FIG. 3, according to some embodiments. The Catalog Manager system 314 includes automated scraper/crawler 710 that crawls various data sources at scheduled intervals to data mine or collects updates to existing content. The scraper 710 aggregates various type of content, such as consumer product content, from various data sources. The scraper 710 may be configured to crawl websites 702 over the network, or flat data files 704 that may be available on either public or private networks, and on consumer product information 706 that may be available over a network or manually provided. Consumer product information 706 may refer to any other source of information, usually provided via API in XML or other format. This includes direct database access, subscriber APIs, and manually entered content from subscriber's documents and files, such as consumer product data sheets or catalogs. In some embodiments, the data sources are targeted data sources in which the scraper 710 is programmed or scheduled to crawl. In some embodiments, the scraper 710 is designed to crawl a group or category of sites. Data mining can also be accomplished by collecting manual entry 712 of data at websites 702, from flat data files 704, or from direct consumer product information 706. It will be appreciated that crawling for information may include any type of crawling known in the art, and is not limited to consumer product information 706. These features allow for the Catalog Manager System 314 to dynamically update its catalog and other data from information gathered from a plurality of data sources in a recurrent and consistent manner.

Once raw data is collected, it may be stored in data storage 714. The stored data may be further processed and re-deposited into storage 714 through a data cleansing process 716. The raw data may be cleansed, to consolidate, fill in gaps, and generally validate the data for further processing or use. In some embodiments, once the data are aggregated, it may be parsed and reorganized or categorized. The data cleansing component 716 also includes various tools to verify the data and make it consumable by the various parts of the Engage Engine 302 or to be utilized by the EE products 340. In some embodiments, rules are configured, such as for example by the Recommendation Engine 316 to utilize the parsed and cleansed data in a particularized way. In some embodiments, the data cleansing component 716 has its own separate storage (not shown) to separately store the parsed and cleansed data. In some embodiments, the data storage 714 may be one or more storage components structured to store and segregate the raw data collected by the scraper 710 and cleansed data processed by data cleansing 716.

FIG. 7B is a block diagram illustrating the data cleansing component 716 in further detail, according to embodiments. A data validator tool 720 receives data from a number of different data sources. A website scraper 722, as previously described with respect to scraper 710, crawls various websites over the network to collect relevant data. The data feed reader 724 aggregates data feeds (such as RSS, blogs, other XML feeds and so on) from many sites over the network and provides the data to the data validator tool 720. A flat file reader 726 aggregates data from documents created in other applications over either private or public networks.

The data validator 720 verifies and parses the data to be further processed and distributed by a data migrator 728. Data validator 720 applies, business rules on the data to ensure its integrity and consistency. Data migrator 728 drives data to different application instances that are running on the Engage Engine 302 platform. In this way, every application contains a subset of required data locally. This is done for performance as well as for security reasons. The data migrator 728 then distributes the parsed data to various application 732a to 732n (e.g., Showcase 1, Buying Guide 1, Buying Guide 2, AdverGuide 4, and so on) and/or to a master catalog database 730. Consumer product content stored in the master catalog database 730 may be provided to various EE products 340 at various sites by a catalog data feed 736. A content management interface 729 allows various consumer products and content in the master catalog database 730 to be accessed and edited in order to make manual updates and corrections directly to the stored product data. In some embodiments, data is not only cleansed, but may also be “cross-pollinated,” meaning that if one data source has enough extra data on a particular product it may be crossed-over to patch up any holes from another data source. This ensures that every piece of data is as complete as possible. Also, the validation process matches up identical products and consolidates them.

FIG. 7C is a flow diagram illustrating the operation of the Catalog Manager system of FIGS. 7A and 7B. At step 740, the Catalog Manager 314 runs a data mining process at a scheduled time. At step 744, the Catalog Manager 314 reads catalog configuration files to determine which reader component to execute on a data source (website, flat file, consumer product information, and so on). At step 748 collected data is stored in raw form. At step 752, the raw data is validated based on business rules. Examples of such rules include whether a particular consumer product type or piece of content is marked as inactive or unavailable for further processing. Based on the rules, the raw data is verified and/or corrected. At step 756, the raw data is migrated to different applications and re-deposited for storage. The different applications may be any of the EE products 340 or any applications within the Engage Engine 302. At step 760, the data is exposed to applications through XML feeds. In some embodiments, this cleaned, validated consumer product data may be provided as a service to subscribers who are interested in using the Catalog Manager 314 outside of an Engage Engine 302 EE product 340.

FIG. 7D is a screenshot of a master data list 770 of information shown in CM interface 772 scraped and collected by scraper 710 stored and manage by the Catalog Manager 314 of FIG. 3, according to some embodiments. For illustration purposes, hardware products are shown, however, it will be appreciated that the data list 770 is generated for any consumer product or category of products required by the needs of the subscriber. The master data list 770 organizes each entry based on a hardware category of computer products (e.g., desktops and notebooks) and a website location 774 such as Best Buy, Costco, Stables, Amazon, and so on. Each entry in the list 770 further identifies a unique ID number for each website location and which language the website is in. It will be appreciated that the data may be organized based on other criteria besides “hardware category” and “Language.” The items of a particular category are identified as “Active Product(s) Counted” at each of the website locations. For example, the first entry, the retailer website is Best Buy, and the scraper 710 counted 85 notebooks featured at this particular website.

FIG. 7E is a screenshot of a detailed item-by-item list 780 of data in the Catalog Manager 314, according to some embodiments. Each entry of the item-by-item list 780 includes useful information about each item, such as a title or description of the item, a unique identifier (i.e., stock keeping unit (SKU)), and other attributes of a category of consumer products or items, such as in the case of computers, hard drive, processor, processing speed, and price. Each entry additionally includes an editing link 782 to an editing interface 786 for each item in the list 780.

FIG. 7F illustrates an example of an editing interface 786 for an item in list 780, according to some embodiments. The editing interface 786 includes more detailed information about the item, including various attributes of the item. Each of the attribute fields 788 may be populated during the scraping and parsing process as information is collected by the scraper 710. Each of the attribute fields 788 may also be manually edited to enter manual changes of any of the item attributes. For example, to correct errors, update changes in status, changes in consumer product features, upgrades to functionality, and so on. The changes made to the attribute fields 788 in the editing interface 786 are stored in the Catalog Manager 314, and may be updated or used for optimization by other subcomponents of the Engage Engine 302.

Optionally, the editing interface 786 may include a preview window 790 that provides a live preview of the source of the data used to populate the item described in the editing interface 786.

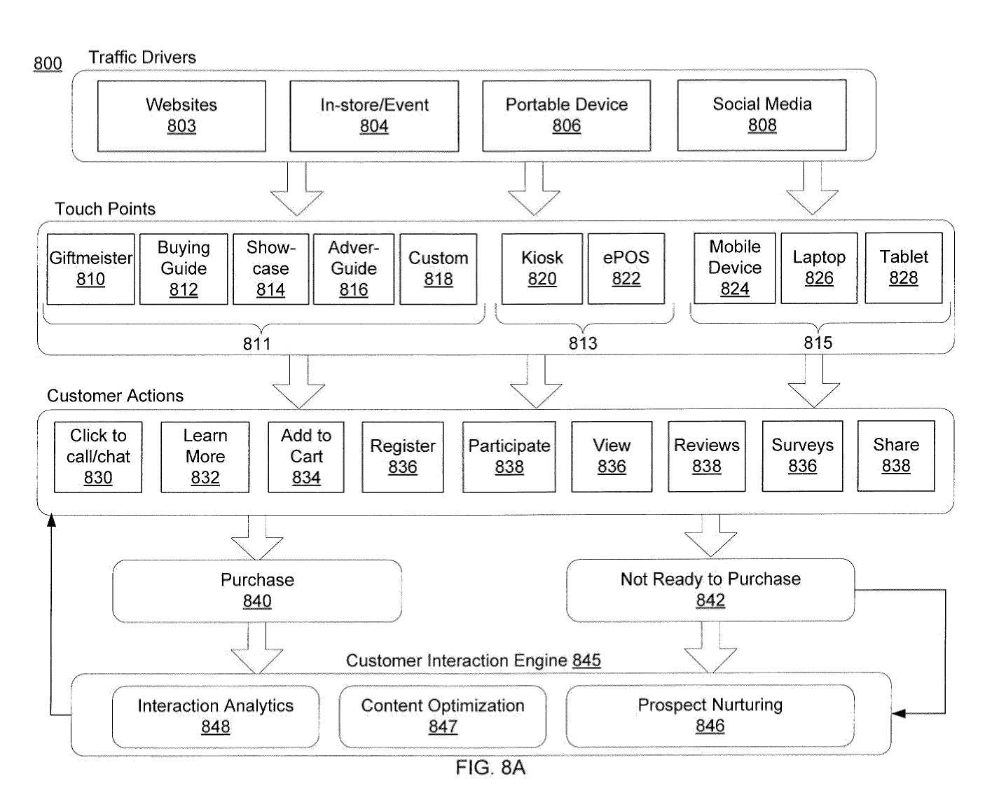

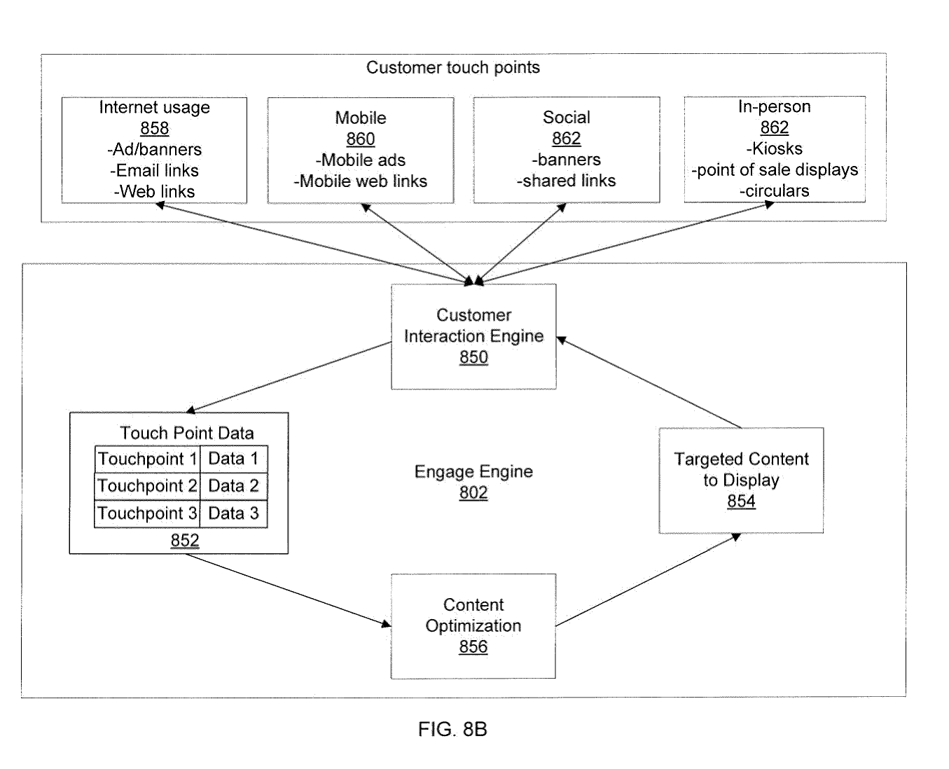

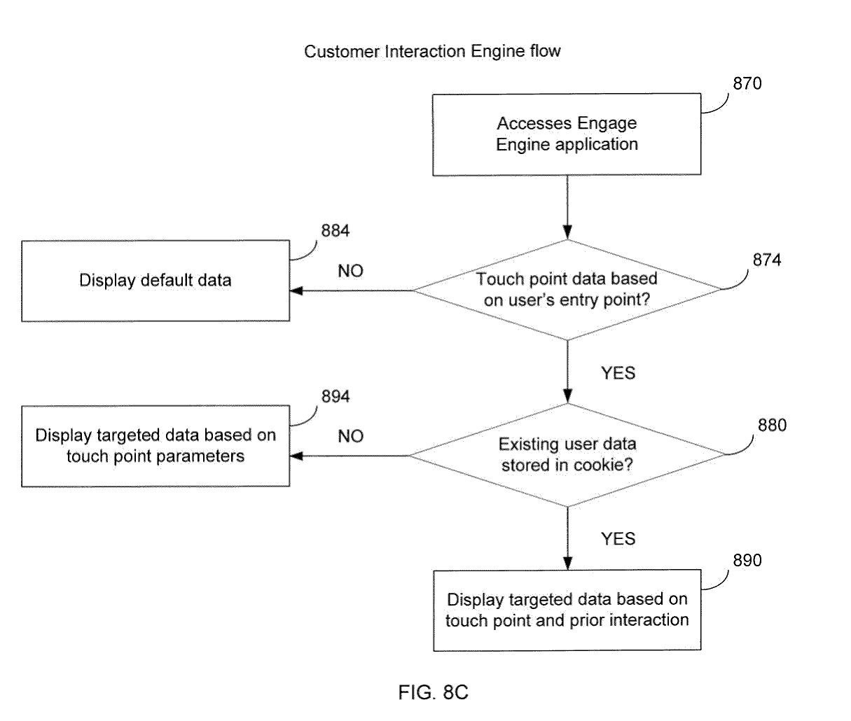

FIG. 8A illustrates various customer actions which may be monitored by the CIE 318, 845 of the Engage Engine 302 in FIG. 3, according to some embodiments. The traffic drivers of an Engage Engine system 800 includes websites 803, in-store/in-person touch points 804, portable devices 806 and various social media sites 808, as previously described. Consumers may access various touch points though these traffic drivers. Touch points include several Engage Engine 302 EE products 811 such as the Giftmeister 810, Buying Guide 812, Showcase 814, AdverGuide 816, and other customized EE products 818. These EE products 811 include interactive modifiable content, and may be displayed at any of the traffic drivers. Touch points also include physical sales devices 813, such as Kiosks 820, and electronic point-of-sale (ePOS) devices where applications with interactive content may be uploaded, including any of the EE products 811. Touch points also include electronic devices 815 in which consumers/visitors may access applications such as mobile devices 824, laptops 826 and tablets 828.

Customer prospects have access to the content provided by the Engage Engine via any touch point to interact with content embedded in applications such as the EE products 811. A number of different customer actions in which the customer prospect is engaging in the content may be monitored by the CIE 845. These include click actions such as click to call/chat 830, actions to request learning more about certain content 832, and adding objects to carts 834 at online commerce sites. Other actions include registering 836, participating 838 in some content-related activity through the touch point, and selecting/viewing content 836. Customer prospects may also engage in posting reviews 838, participating in surveys 836, sharing information 838, and so on. A number of these actions lead to the customer prospect making some sort of purchase 840. Purchases 840 include any type of purchases that may occur at a website, such as click-to-buy transactions. The click-to-buy transactions may additionally include secure e-commerce transactions, i.e., e-commerce secure banking (CC) transactions. However, the action of not purchasing 842 some item may also be useful information for the CIE 845. All of the above information may be tracked and recorded by the CIE 845 to detect trends and patterns that may be utilized by the rest of the Engage Engine 302 to make decisions about EE product content, for optimization processes, to predict and to gain valuable insight of visitors and content embedded in EE products and other applications.

The CIE 845 includes a prospect nurturing tool 846, content optimization 847 tool, and interaction analytics tool 848. The prospect nurturing tool 846 describes the analytical functions of CIE 845 that performs appropriate actions based on the context of the customer prospect and the consumer product. In some cases prospect nurturing 846 may serve up appropriate content for the specific customer prospect. For example, if the customer prospect has previously looked at a particular customer product or category of products, this would all the CIE 845 to serve up more of the same type of consumer products. In some cases, prospect nurturing 846 may provide customer data to a third-party customer relationship management solutions, such as SalesForce.com, so that a sales rep can contact the customer prospect directly about a particular product. Interaction analytics 848 is the data information, e.g., displayed content, stored content, data collected about customer prospects, actions, activities, interactions and so on, that the CIE 845 relies on for its operation. Content optimization 847 reviews data information that it has gathered or has access to, content displayed in instances of the EE products 340 or data stored in the Catalog Manager 314 and provides updates to content or makes recommendations to optimize content.

FIG. 8B is a block diagram illustrating a customer interaction system 800 according to some embodiments. The customer interaction system 800 includes a customer interaction engine 850 in the Engage Engine 802, which synthesizes information provided by customer prospects from various touch points 857 into a usable format, touch point data 852. The touch point data 852 may be further processed by a content optimization tool 856 evaluates the touch point data 852 for use by the Engage Engine 802 to update content or make recommendations. For example, the content optimization tool 856 may interface with the Recommendation Engine 316 and/or the BI 310 to determine whether existing content can be optimized. The data collected from customer prospects may be mapped by content mapping or applied to one or more optimization rules, i.e., optimization rules of the Recommendation Engine 316, such that the Engage Engine 802 may modify, replace, or optimize content based on patterns, trends, preferences, and other target factors evaluated from the touch point data 852. The targeted content displayed to the user via a content display tool 854 may be modified or replaced depending on the optimization results of the content optimization tool 856. In some embodiments, the content display tool 854 may interface with the Content Management System 312 or may be an integral part of the Content Management System 312.

Any data derived from the behaviors, and interactions of the customer prospect may be considered and tracked by the customer interaction engine 850. These include click actions such as click to call/chat, requests, adding objects to carts, registering, participating in some content-related activity, and so on. All these interactions may be detected via customer touch points 857. Customer touch points 857 include any type of internet usage 858, such as through advertisements, banners, email links, web links, and so on. Include also are mobile touch points such as advertisements on mobile devices and mobile web links. Customer touch points 857 include social media touch points such as banners and shared links. Customer touch points 857 also include in-person touch points 864, such as kiosks, point of sale displays and circulars inside a physical location of a store. Information from the interactions of any of these touch points 857 may be tracked and utilized by the customer interaction engine 850.

FIG. 8C is a flow diagram illustrating an example of the operation of the customer interaction engine 850 of FIG. 8B, according to some embodiments. At step 870, an Engage Engine application is accessed by a customer prospect (“user”) via content that may be serviced by the Engage Engine 302 or any of the Engage Engine 302 EE products 340 to any of the touch points previously described. At step 874, the content optimization tool 856 applies a rule whether touch point data was provided based on the user's entry point at step 870. If data was not received, then at step 884 default data is displayed to the user. If data was received, then at step 880 another rule is applied for further optimization, is existing user data stored in a cookie(s). If existing data is not stored, then at step 894, targeted data is displayed based on any received touch point parameters. If existing data is stored, then at step 890, targeted data is displayed based on both the received touch point data and the prior interaction by the user. Thus, optimization of the displayed data to the user is achieved upon the user accessing the application at a respective touch point.

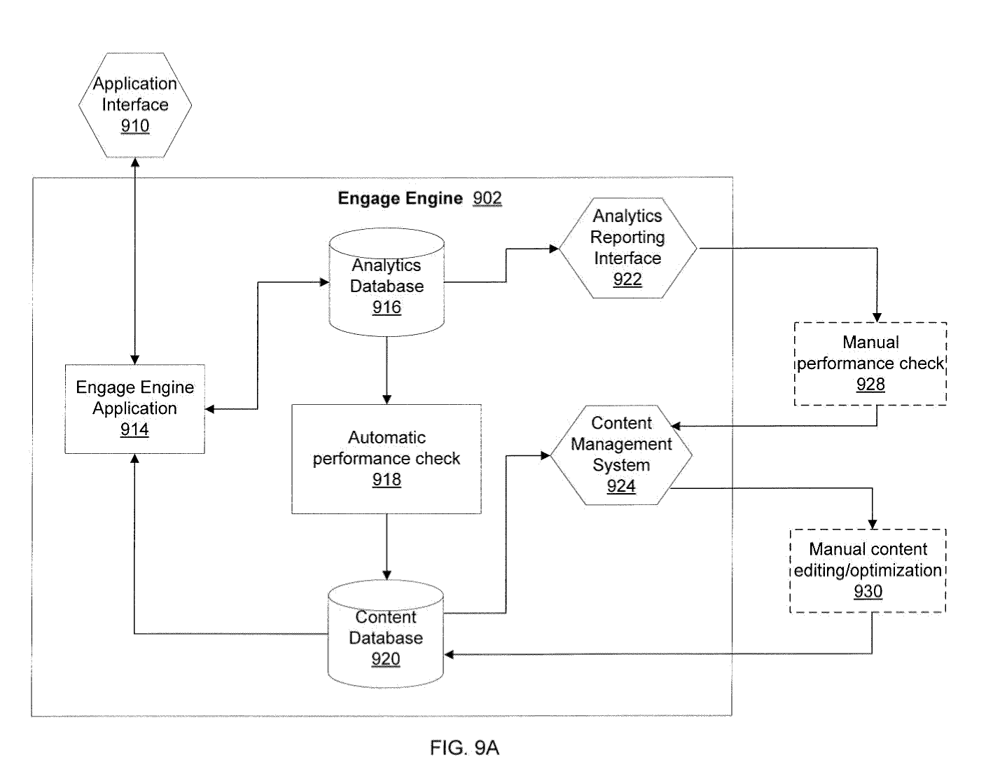

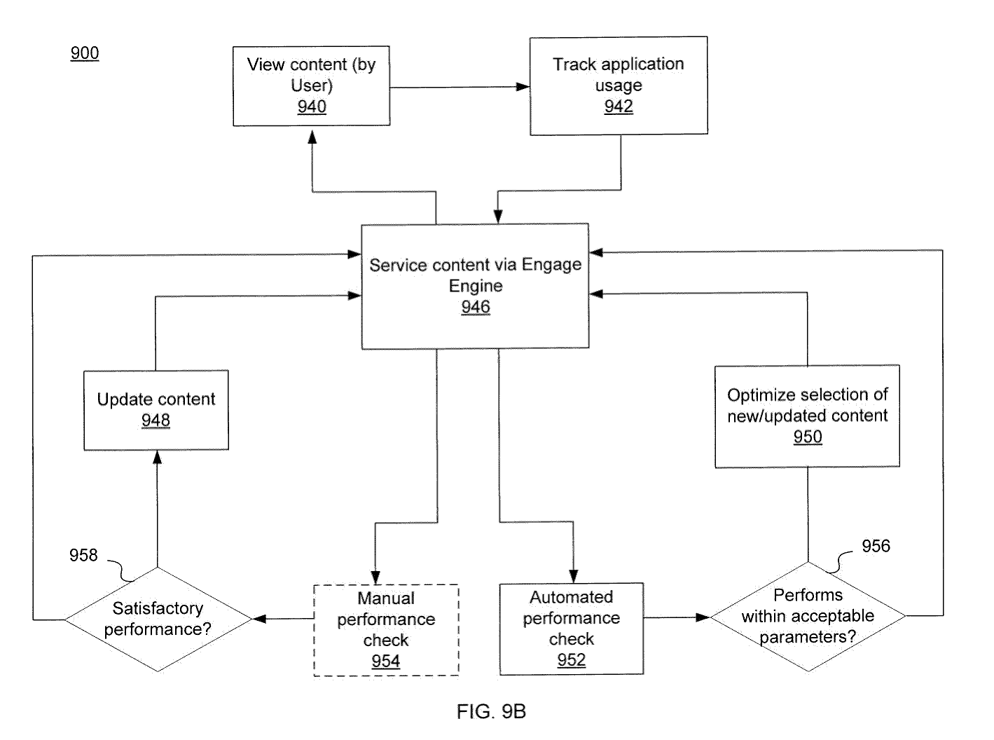

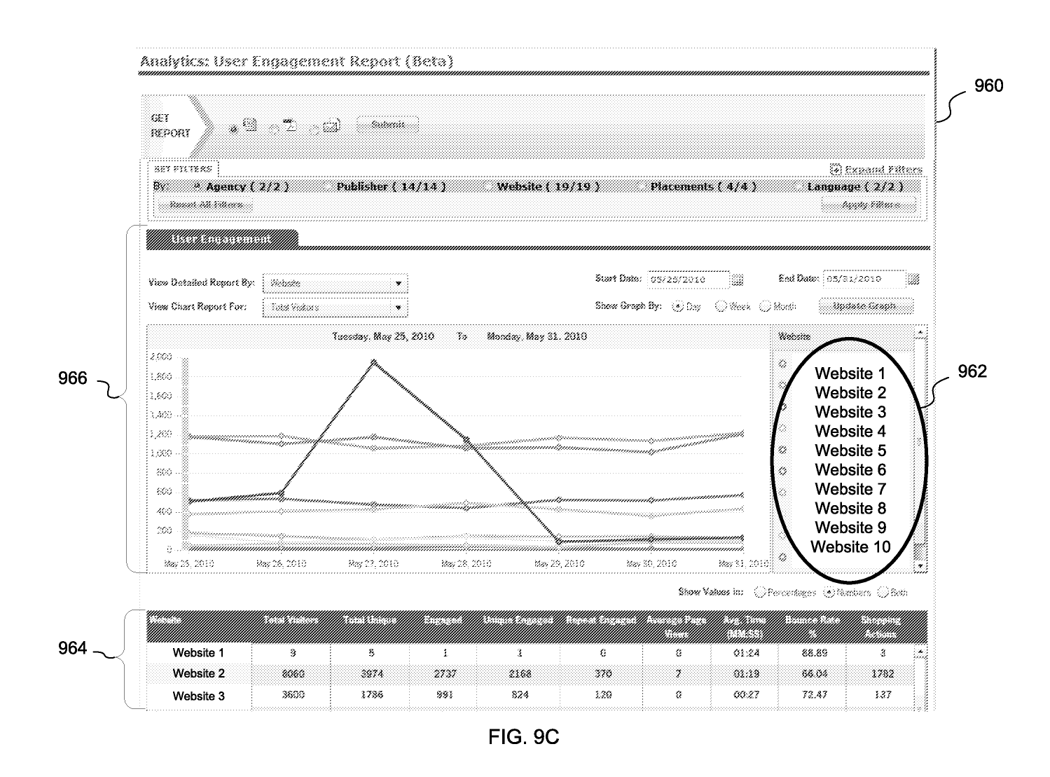

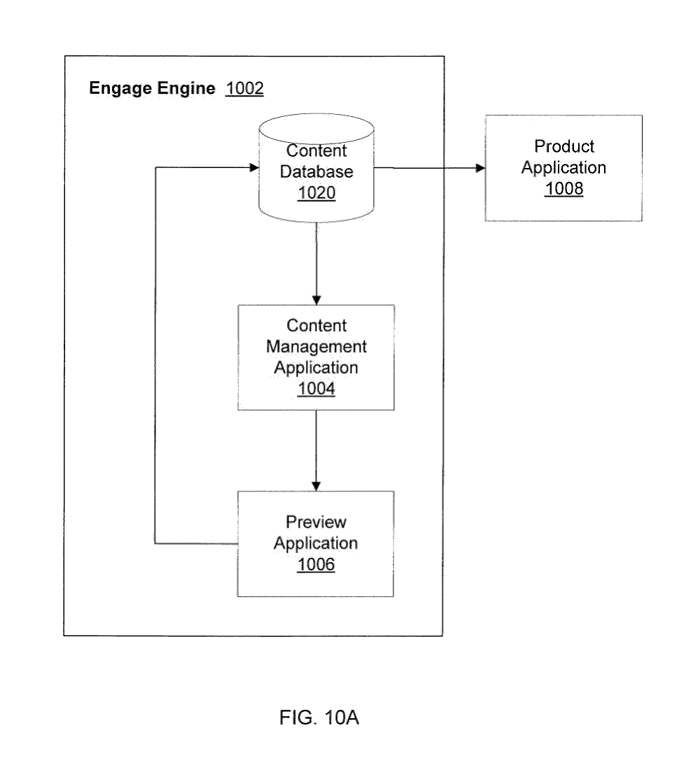

FIG. 9A is a block diagram illustrating an integration of the BI system 310 and CIE 318 of FIG. 3 in Engage Engine 902, according to some embodiments. An engage engine application 914 services an EE product provided to a consumer prospect visiting a site that displays the EE product via an application interface 910. The consumer prospect may interact with content provided at the application interface 910, and information about consumer prospect and the interactions may be recorded by the Engage Engine 914. The information collected about the consumer prospect may then be utilized by the Engage Engine Application 914 to generate analytics and store in the analytics database 916 about the consumer prospect, groups of consumer prospects or categories of consumer prospects. Through an analytics reporting interface 922, which may be part of the BI 310, subscribers may request consumer product information updates, data analysis, customer trends and patterns, and other detailed analytics about their consumer products, customer prospects, and general market space. Subscribers may also request any of the above information in reports and forms for ease of use and for other business purposes, which are generated by the BI 310. Upon request by the subscriber, the analytics information may be retrieved at the analytics reporting interface 922 from the analytics database 916.

The analytics reporting interface 922 of the BI 310, may be used to view usage statistics, allowing the subscriber to use that data to make more informed marketing decisions, assess the performance of the content being serviced, such as consumer products they are selling through the Engage Engine 302, and to collect useful data on their customer prospects' purchasing habits.

The analytics information supplied by the BI system 310 may be further utilized and processed by the CIE 318 to allow further performance checks and optimization processes such as reviewing traffic information, click-through information, customer preferences, purchasing/interactive behavior insights and so on. The CIE 318 includes an automatic performance check tool 918 which conducts an automatic performance check of the EE products 340 based on analytics information which may be stored in the analytics database 916 and data or updated content that may be available in a content database 920. The automatic performance check tool 918 may be automated by scheduling a performance check process periodically or may be initiated in response to some event, such as updates to EE products 340 or content being detected. The automatic performance check 918 also includes a process in place for optimizing EE product content and/or analytics information and updating the optimized data in the content database 920, which may be in part based on analytics provided and updated to the analytics database 916 as new information comes in. The optimization of content and data in the Engage Engine 302 thus allows for constant monitoring of updates to the content and the analytics reporting of the BI 310. In some embodiments, automatic notifications to users may be generated when analytics and EE product features are optimized. EE product content may be automatically updated based on the findings of the CIE 318 when the content is updated in the content database 920. When content is updated CMS 924 updates the optimized content in EE products 340.

In some embodiments, manual performance checks 928 are conducted and entered into the CMS 924 to make manual changes to EE product content. Additionally, manual content editing or optimization 930 may be conducted to update content in the content database 920.

FIG. 9B is flowchart illustrating the operation of the BI and CIE system in FIG. 9A. At step 940, content is viewed by the user and at step 942, user interactions with the content via application interface 910 is tracked and monitored. At step 946, content is serviced via Engage Engine 902. The Engage Engine services 946 include initiating automated performance checks 952. During automated performance checks, at step 956, the system checks to determine whether the EE product content being checked is within acceptable parameters. If the EE product content is within acceptable parameters, feedback is provided to be considered by the servicing of content at step 946. If the reviewed EE product content does not meet expected parameters, the content is updated or replaced during an optimization process at step 950. In some embodiments, performance checks and updated may be conducted manually at step 954. If a manual performance check yields a satisfactory performance, at step 958, feedback is provided to be considered and/or monitored when servicing the content at step 946. If manual performance check yields an unsatisfactory check, then the content is updated or replaced. The Engage Engine 902 receives content updates 948 and optimization of new and/or updated content at 950.

FIG. 9C illustrates an example of an analytics interface 960 for viewing one or more analytics in a report generated by the BI and CIE system 310, according to some embodiments. The sample report displayed by the interface 960 compares the total number of visitors to a set of websites 962 during a time frame of May 25, 2010 to May 31, 2010. A group of parameters 964 are tracked relating to a count of the number of visitors to each respective website in the set of websites 962. The parameters for the first three websites are shown for illustration purposes. The parameters in this particular report include the total number of visitors, total number of unique visitors (each visitor is counted once), the number of visitors who engaged in some manner with some content on the webpage, average pages viewed, average time on the website, bounce rate (percentage of people who leave the site before any interaction), and the number shopping actions. Each one of these parameters may be used to generate a graphical representation comparing the statistics for any subset of websites 962. A graphical representation 966 comparing the total number visitors to each of the websites in the set of websites 962 is shown as an example. The interface 960 additionally includes several editable fields and preference buttons to change the report or specify certain attributes when generating the reports.

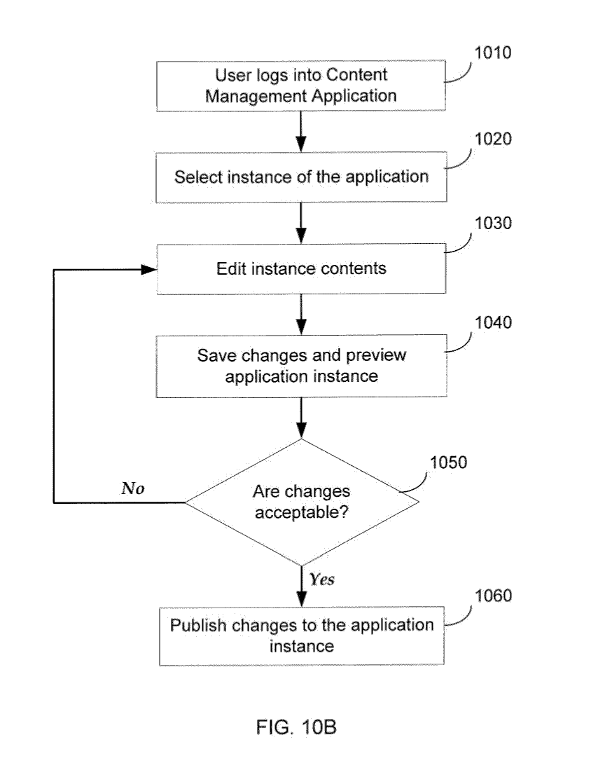

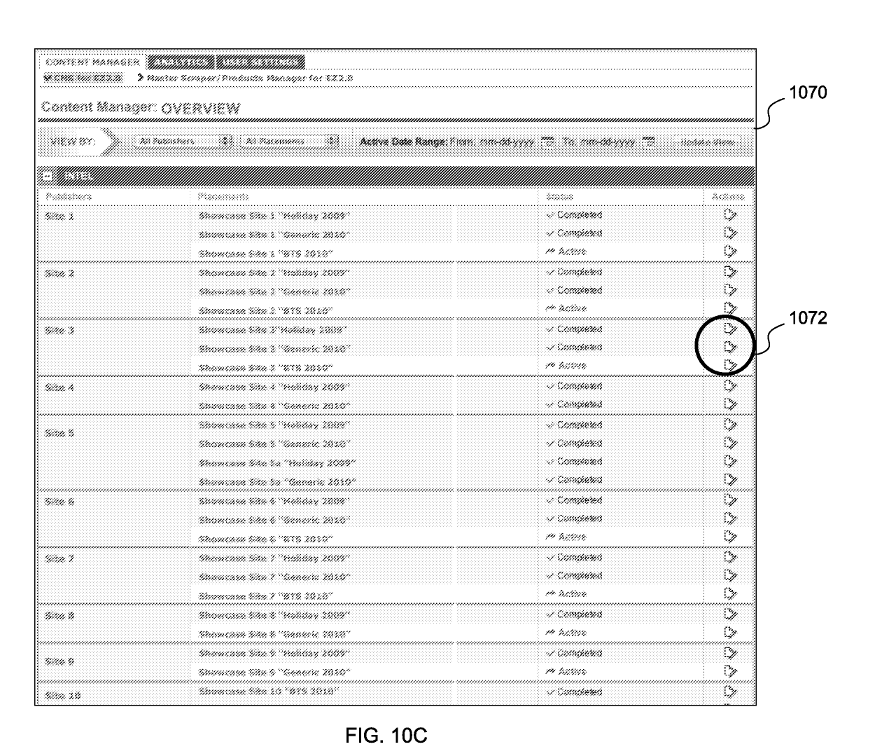

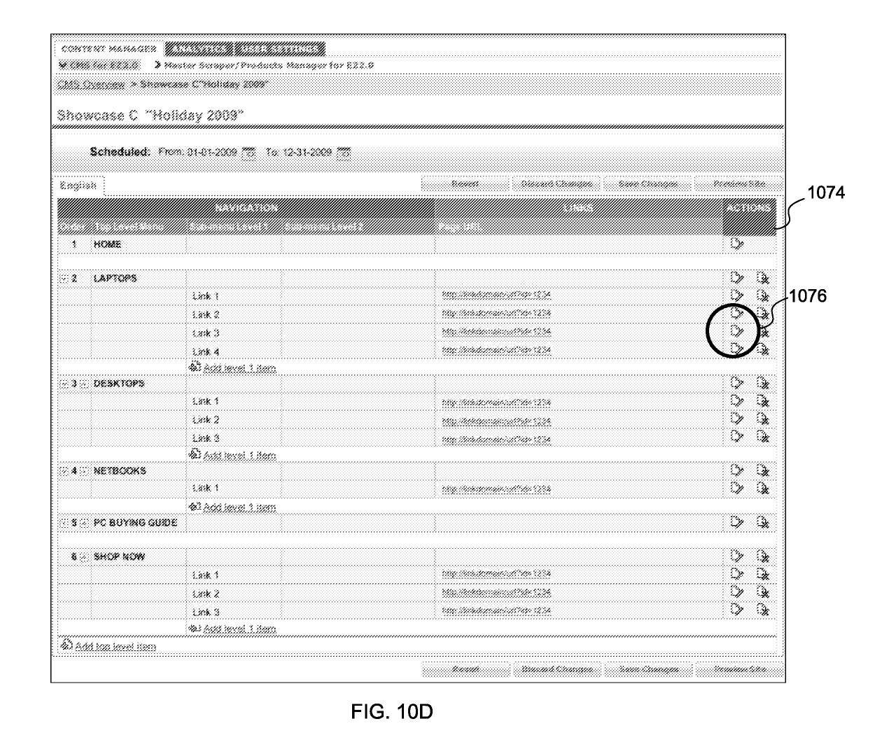

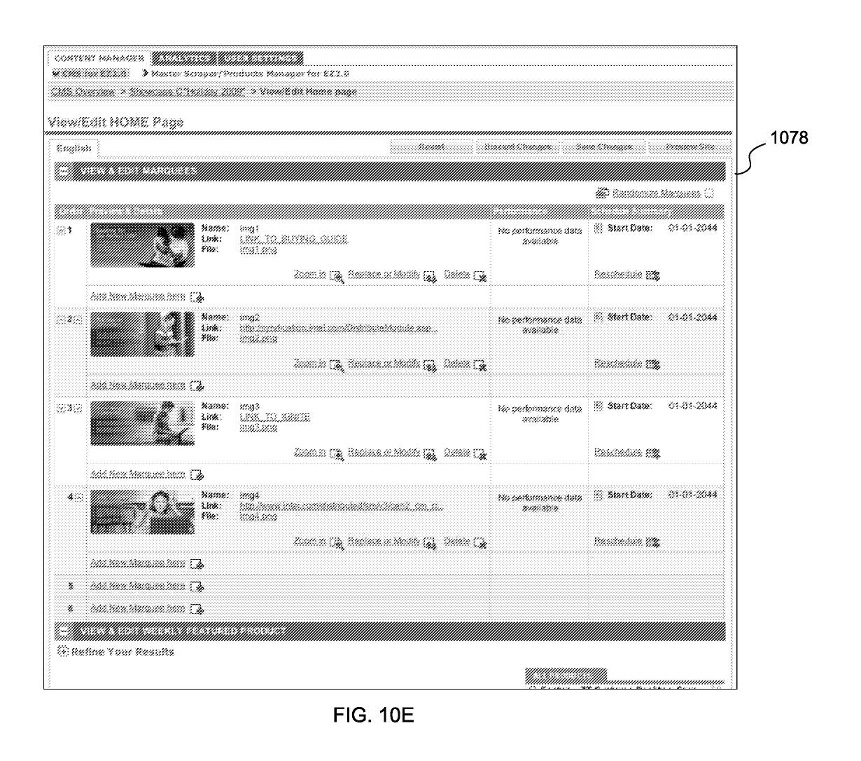

FIG. 10A is a block diagram of the CMS 312, according to some embodiments. As previously described, the CMS 312 allows the subscriber to manage EE products 340 and physically update any content in EE products 340. A content management application 1004 of the CMS 312, is notified of and receives updates to content or new content stored in a content database 1020 of Engage Engine 1002. The content in the content database 1020 may be updated, optimized and stored in accordance with previously described methods. When a content update occurs, the content management application 1004 initiates a preview application 1006 to identify the content and make changes in accordance with the notifications received by the content management application 1004. The modified content is published and stored in the content database 1002, where the newly updated content may be uploaded onto the associated EE product via an EE product application 1008.

The content management application 1004 may automatically update the content upon notification or updated may be scheduled in periodic intervals or the changes can be made manually. In some embodiments, the content management application 1004 may be triggered to update content in response to other information provided by the Engage Engine 1002, such as insights to consumer/visitor activity from BI 310 or CIE 318. The content management application 1004 may also be triggered based on certain rules that are processed by the Recommendation Engine 316 as previously described.

FIG. 10B is a flow chart illustrating the operation of the content management application 1004, according to some embodiments. At step 1010, the user logs into the content management application 1004. Once logged in, the user may, at step 1020, select a particular instance of the application to modify, replace or update. Alternatively, selection of instances of the application may be automated according to a schedule or in response to a trigger event to initiate an evaluation of whether the particular instance is to be updated. At step 1030, the contents of the instance are edited. The editing process at step 1030 is manually done, or may be automated. The automated editing of instances may occur when the Engage Engine 1002 detects updates or changes to the content of the instances, or it may be triggered by some rule analysis or optimization processed initiated by the CIE 318, BI 310, and/or the Recommendation Engine 316. At step 1040, the changes to the instance are saved and previewed to determine if the changes are acceptable, at step 1050. The changes may be saved and previewed manually or by an automated process. If the changes are not acceptable, then the editing process is repeated at step 1030. The editing process may be engaged by relying on a different set of rules in the Engage Engine 1002. If the changes are acceptable, then at 1060, the changes to the application instance are published in the application or EE product 340.

FIG. 10C is a screenshot illustrating an example of a content list 1070 managed by the CMS 312, according to some embodiments. The content list 1070 example illustrates special campaign content pages of the Engage Engine 302 EE product “Showcase.” The first column lists the subscriber, the second column describes the “Showcase” EE product, and the third column lists the status of the campaign (when the template was completed/edited and whether the campaign is active). Each item in the list additionally has an editing link 1072, which opens up a consumer product list interface 1074 for the particular campaign when selected.

FIG. 10D is a screenshot of the consumer product list interface 1074 providing a list of consumer products for a selected Showcase campaign “Holiday 2009,” according to some embodiments. The consumer product list interface 1074 provides a list of items that are available for purchase by the customer prospect through the Holiday 2009 ad campaign. Each consumer product is organized by category and has associated a link to the subscriber page where the customer prospect may purchase the customer product. The category may additionally include subcategories of items for showcasing additional special items such as the “Shop Now” entry in the consumer product list interface 1074. For each line of item, a link 1076 is provided to a separate page for editing each item.

FIG. 10E is a screenshot of an editing interface 1078 that opens when the link 1076 is selected, according to some embodiments. The editing interface 1078 lists specific advertisement content, such as a marquee, that is uploaded and managed by the CMS 312. Each content item is associated with its location, effective date, and various other links to further edit, replace or update. Each content item additionally has associated with it any performance information that may indicate how the content is doing and whether any optimization options are recommended by the Engage Engine 302.

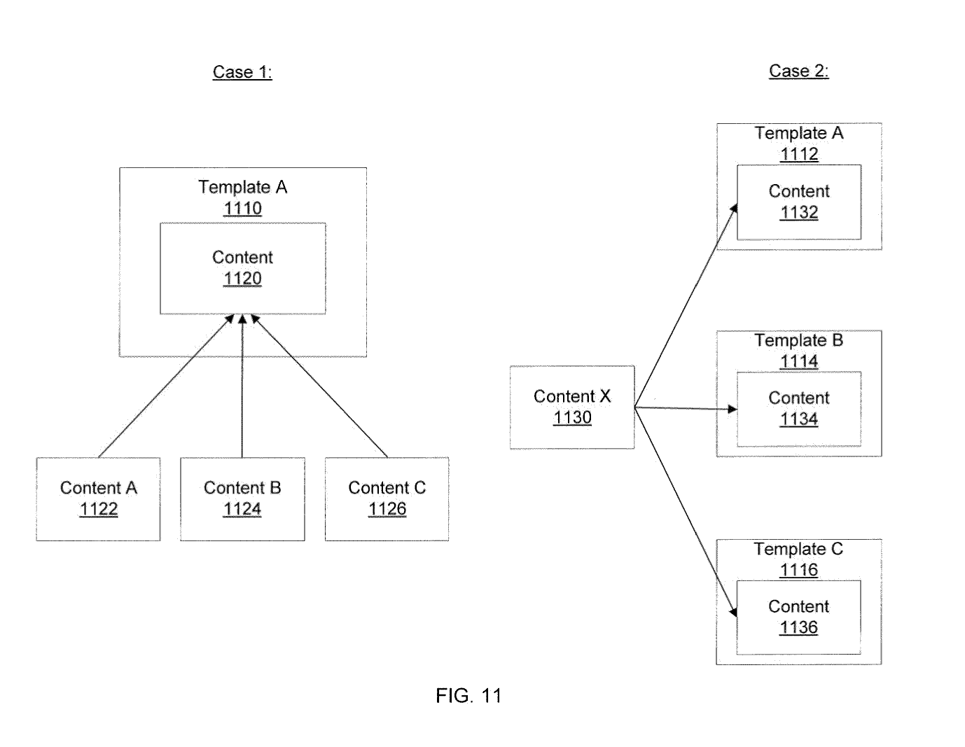

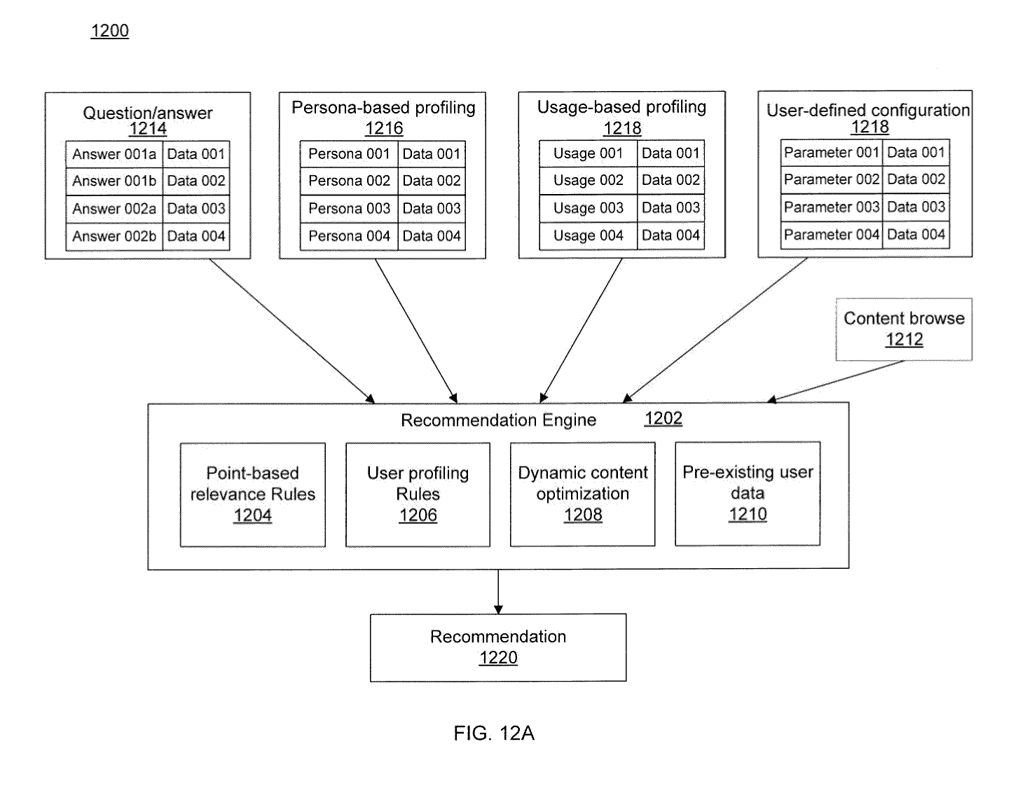

FIG. 11 is a block diagram of various ways in which content may be displayed in templates managed by the CMS 312 of the Engage Engine 302, according to some embodiments. In Case 1, a single template, Template A 1110, may include a content placeholder 1120 that is associated with a plurality of content items, Content A to Content C 1122-1126. If, for example, Template A 1110 is positioned in a plurality of locations (e.g., various different websites), for some of those sites Template A 1110 may display Content A 1122, others of those sites may display Content B 1124 or Content C 1126, and so on. Thus, when the Engage Engine 302 updates or modifies Content A 1122, that content may be simultaneously be updated for all locations of Template A 1110 displaying Content A 1122. Similarly, all locations for Template A 1110 displaying Content B 1124 is serviced simultaneously, and so on. Alternatively, Contents A to B 1122-1126 may be displayed in rotation on multiple locations of Template A 1110. Thus when the Engage Engine 302 updates any one of Contents A to B 1122-1126, the instances of content may be serviced simultaneously for all locations of Template A 1110. It will be appreciated that although content placeholder 1120 illustrates a single instance of content, content placeholder 1120 may represent multiple content placeholders, in which multiple instances of content may be displayed for each placeholder as illustrated by way of example by content placeholder 1120 and Contents A to B 1122-1126.

In some embodiments, templates may be serviced by the Engage Engine 302 according to Case 2. In Case 2, a plurality of templates Template A to Template C include content placeholders 1132 to 1136, each of which may display the same content, Content X 1130 on different templates, A to C. Thus, when Engage Engine 302 services and updates Content X 1130, it is serviced simultaneously across all templates 1132 to 1136 that display Content X 1130 across multiple sites.

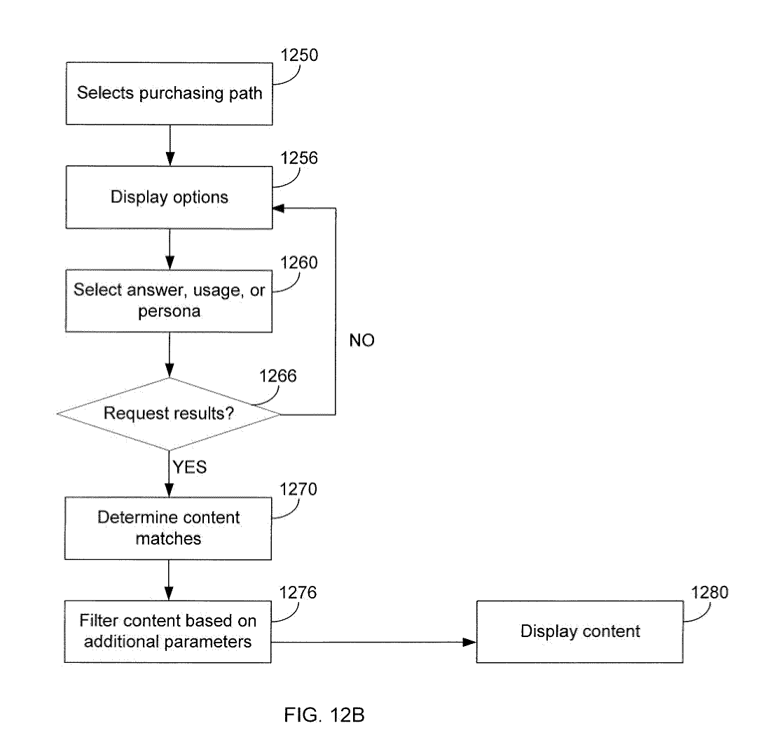

FIG. 12A is a block diagram illustrating a recommendation engine system 1200 according to some embodiments. As previously described, the Recommendation Engine 316, 1202 is a rules-based configuration system that allows subscribers to map content to relevant decision criteria and deliver resulting recommendations 1220. The Recommendation Engine 1202 of FIG. 12A may include any type of rules (e.g., algorithms, if/then/else coding, and so on) for configuring relevant criteria in making the recommendations 1220. For example, the Recommendation Engine 1202 includes point-based relevance rules 1204 and user profiling rules 1206. The point-based relevance rules 1204 may be a set of rules in which certain criteria or set of criteria is determined based on a participant's actions, responses, decisions, reactions, and so on. Each action (e.g., selection, response, choice) taken by the participant is assigned a value or several values, as it relates to a particular mapping. These values feed into algorithms and/or that determine how consumer products, content, and/or features are mapped. The user profiling rules 1206 may be a set of rules to identify and categorize various attributes of a participant's profile. The recommendation engine 1202 may additionally include dynamic content optimization tools 1208 that evaluate, based on rules or set of rules, new and updated content of the Catalog Manager 314, current customer information of the CIE 318 and/or analytics from the BI 310 to dynamically serve up and optimize existing content. The optimization of content may be an automated process or a dynamic response based on manual updates and addition of new content.

The Recommendation Engine 1202 may further include a tool for using criteria based on pre-existing user data 1210 to provide the recommendation(s) 1220. For example, the Recommendation Engine 1202 may draw from previously established criteria or data of a visitor or returning visitor to make certain recommendations.

The Recommendation Engine 1202 draws from a number of different data types, which may be stored anywhere in the Engage Engine 302, to apply to its rules database or in determining its recommendations 1220. For example, the Recommendation Engine 1202 extracts question/answer data 1214, which is a collection of responses by customer prospects to one or questions (e.g., Answer, Data) that they may have responded to in a visit to the subscriber's content page, web page, and so on. In some embodiments, the Recommendation Engine 1202 may utilize persona-based profiling 1216, which is a criteria that may be used in one or more EE products 340 of the Engage Engine 302 of FIG. 3. For example, when a customer prospect selects a particular persona, and in some cases in addition to other criteria, the Recommendation Engine 1202 generates a set of recommendations 1220 based on the persona criteria. The Recommendation Engine 1218 may additionally draw from usage-based profiling 1218, which may be a record for tracking visitor selections and usage of certain consumer products, which can then be utilized by the Recommendation Engine 1202 to generate future recommendations 1220 based on the usage patterns.

In some embodiments, the Recommendation Engine 1202 may be configured to detect when content browse features 1212 are made available and may determine when such content browse features 1212 may be recommended. For example, special offers periodically become available on certain consumer products or the particular site or type of visitor may have indicated a preference to view certain content or set of content directly to bypass any other interactive features of a website, for example. Based on a set of criteria determined, the Recommendation Engine 1202 may draw from the content browse data 1212 to make certain recommendations 1220.

FIG. 12B is a flow diagram illustrating an example of the operation of the Recommendation Engine 1202 of FIG. 12A, according to some embodiments. At step 1250, a customer prospect selects a purchasing path, where at step 1256, a set of options are displayed to the customer prospect. From the display of options, at step 1260, the visitor may select from a set of choices, respond to questions, provide preferences, identify particular usage needs, and/or select a persona that may identify a particular set of criteria. If results are requested at step 1266, the Recommendation Engine 1202 determines matches based on the customer prospect's selected parameters or entries at step 1270. For example, in the case of consumer shopping, a set of consumer products may be selected by the Recommendation Engine 1202 based on the entered criteria. If no results are requests, the set of options at step 1256 may be re-displayed or a new set of options speculating the interest of the visitor/consumer. At step 1276, the set of content selected by the Recommendation Engine 1202 may be further processed and filtered based on additional parameters. At step 1280, the recommended item or set of content is displayed to the customer prospect.

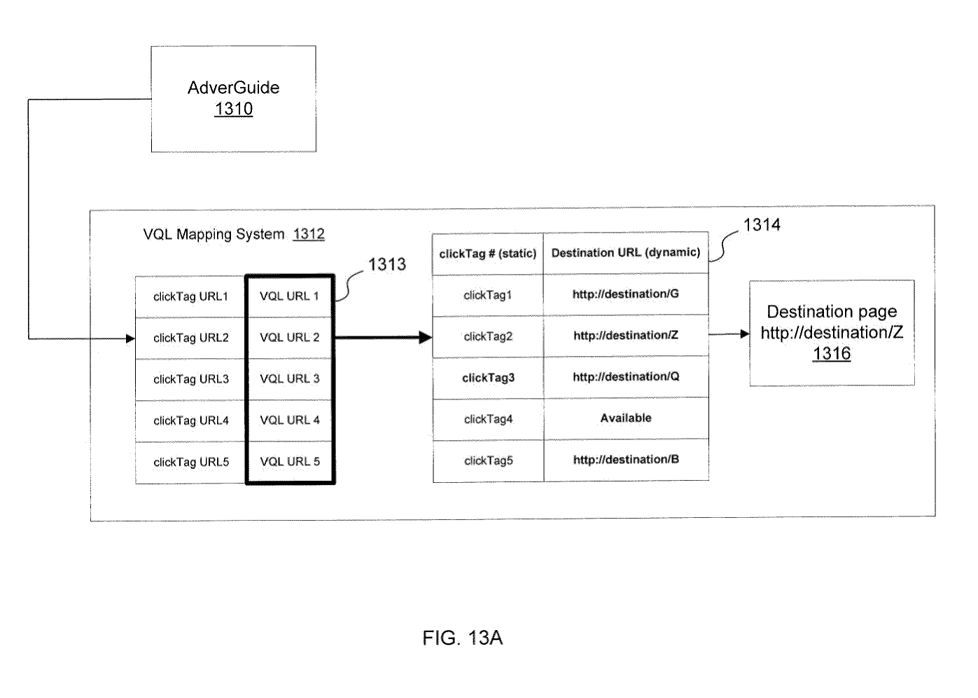

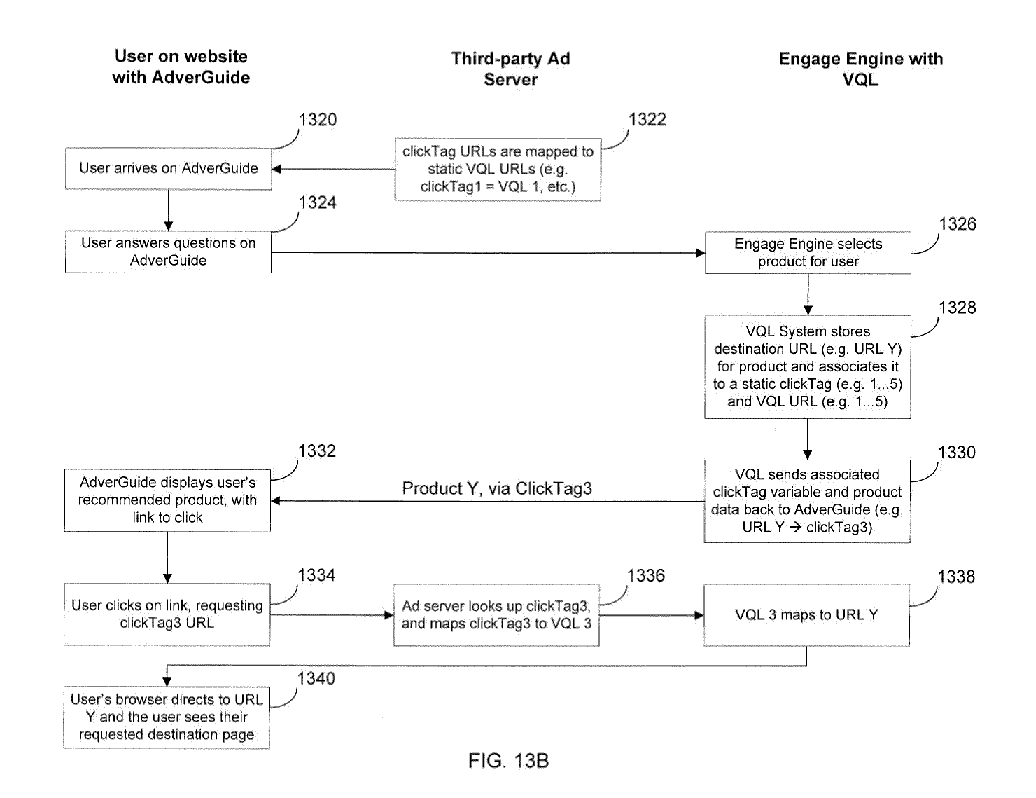

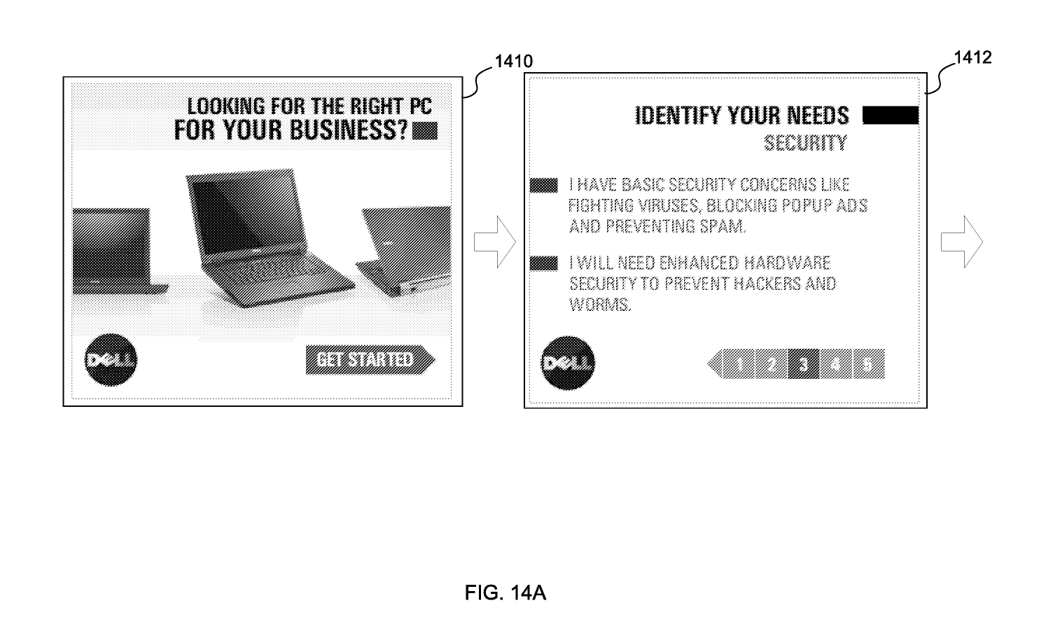

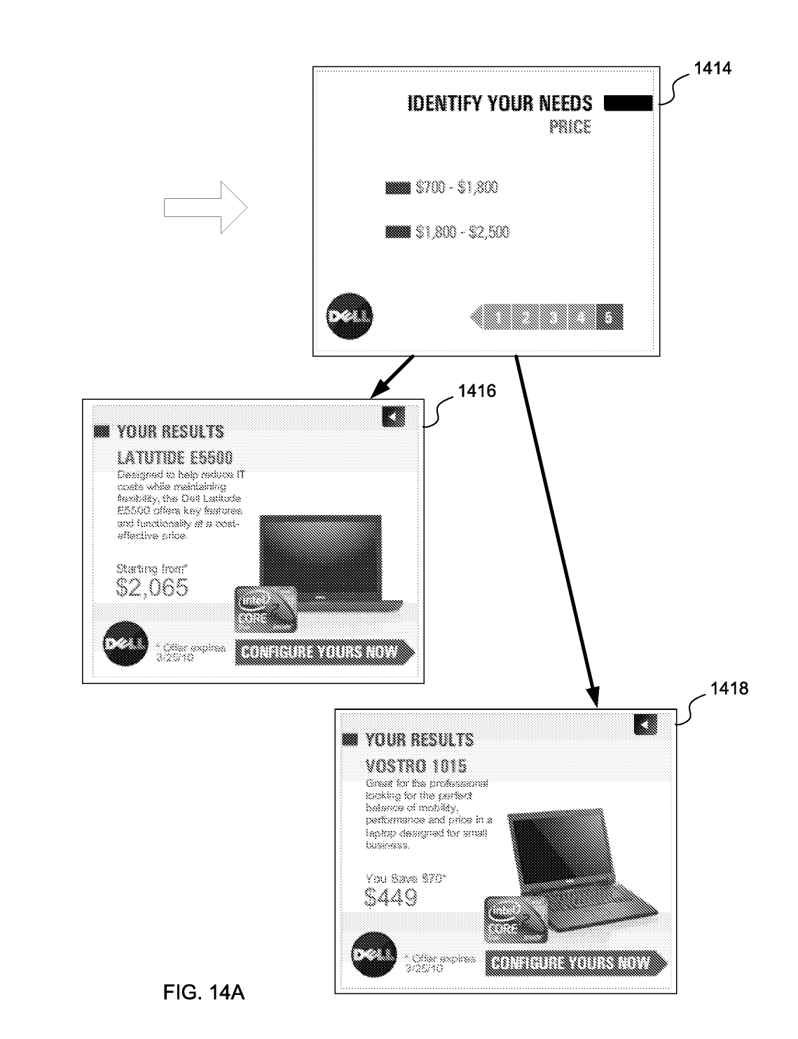

FIG. 13A is a block diagram illustrating a virtualized queuing system 1300 for directing a customer prospect to a destination Uniform Resource Locator (“URL”) at the backend in a sample Engage Engine 302 EE product, the “AdverGuide” 1310, according to some embodiments. On a generic ad unit interface, various traceable links, such as click tags, clickTags, or URL redirects, are typically provided for a customer prospect to be directed to a particular destination link. A click tag or URL redirect may be a URL that is associated with a desired destination URL by a third party. Third-party clickTag mapping systems are designed to track how many people are clicking to a particular URL (destination) on a web site. The clickTags track this by substituting the final destination URL with their own fixed URL at a third-party server, such as a third party ad server. A third-party server may be provided by any third party capable of providing content, such as ad units (or other interfaces) to multiple destination websites. The content provided by these third-party servers typically have restrictions associated with them by the third party provider to control the manner in which the content is used or displayed. Thus, when the user clicks on an ad unit and tries to access this new URL, the third-party server tracks this action, and then passes the user off to the original destination. However, because these clickTags are serviced by the third-party server, these clickTags are typically fixed in that, when selected, directs a user of a site to the fixed destination link. What this means for the ad unit is that it limits the number of destinations to which people can be sent to. For each destination, the third party server providing the service requires that their system be used to manually map to a new clickTag URL. This has to be done before the ad is deployed, and cannot be achieved dynamically.

In contrast, in the mapping system 1312 of FIG. 13A, the clickTags of instances serviced by the Engage Engine 302, such as AdverGuide 1310, are not limited to fixed URLs served by third-party servers, as will be described in more detail. A sample instance of an AdverGuide product 1310 is described for illustration purposes. It will be appreciated that other EE products 340 may additionally utilize similar features of the virtualized queuing system 1300. For each clickTag, a virtualization queuing link (“VQL”) 1313, shown in the second column of the mapping system, which function as a placeholder for a destination URL. The placeholders VQL 1313 may be managed and serviced by the Engage Engine 302. In this way, instead of requiring that, for example, clickTag3 always directs a customer prospect to a fixed destination, in the virtualized queuing system 1300, clickTag3 may be configured to direct a customer prospect to any one of a plurality of destinations selected by the Engage Engine 302. Furthermore, the VQS system 1312 may be used for any application that has multiple outbound links that have to go through a limited set of URL redirects or clickTags. Each clickTag URL in the ad unit, such as AdverGuide 1310 is assigned an a VQL placeholder 1313, which in turn can be associated with a dynamic destination URL that can be replaced with the next destination URL selection after the first destination has been asserted (i.e., selected on the AdverGuide 1310 site). The destination URL is dynamic in the sense that a plurality of destination URLs may be associated with each clickTag, and the assigned destination URL may be dynamically exchanged out once a customer prospect has been sent to the desired destination. The clickTag is now free to be assigned to a different destination. Therefore, the VQL placeholders 1313 act as an intermediary between the clickTag and destination URL to allow the destination URL to become dynamic.

More specifically, at the AdverGuide site 1310, the customer prospect may answer questions or provide preferences, and on the back end, the URL mapping system 1312 generates desired destination URLs based on the user's preferences (i.e. a consumer product site or a URL to some destination based on the preferences). In some embodiments, the mapping system 1312 may generate more than one destination, and may be provided to a user in a series. The mapping system 1312 assigns a destination URL to the first available clickTag on the AdverGuide 1310. At the backend, the destination URL is actually assigned to the VQL URL placeholder for the available clickTag. As previously described, the AdverGuide 1310 includes a predetermined number of clickTags on its page, each of which is assigned to a VQL URL 1313 that acts as a gateway to destination URLs. Once a user clicks on the clickTag, the selection data is recorded and the user is directed to the destination URL. The clickTag is then in queue for the next user or selection.

Returning to FIG. 13A, an example of the process described above is illustrated. At the AdverGuide interface 1310, static clickTag URL 2 is selected, which is assigned to VQL URL 2. The mapping system 1312 records the selection of the static clickTag2 and assigns http://destination/Z, which is a URL destination that is dynamically assigned to clickTag2 via VQL URL 2. The user is redirected to destination page http://destination/Z 1316, either on the AdverGuide interface 1310, in a new web browser, on a new tab, and so on. The clickTag 2 is now available for a new destination assignment via VQL URL 2. Thus, VQL URL 2 allows a clickTags that are normally static to be dynamically assigned to a destination URL.

Analogous to the virtualization queuing system 1300 is that of an airport with 5 gates, where each gate is locked down to a destination. Gate 1 is to New York, gate 2 is to SF, and so on. This limits the places one can go for these five gates. Additional gates have to be added in order to travel to additional destination. But, the virtualization queuing system 1300 considers a gate as a mere placeholder for a destination. Depending on when one arrives at the gate, and a complex scheduling system, each gate now allows for travel to multiple destinations, which may be rotated or shuffled around constantly for each gate. Once a plane at a particular gate has left, the gate is now free for a completely different flight.

FIG. 13B is a flow diagram illustrating the process of the virtualization queuing system 1300, according to some embodiments. At step 1320, a user arrives on the AdverGuide page 1310. The AdverGuide page 1310 includes a predetermined number of clickTags mapped to static virtualized queuing links at step 1322. In some embodiments, a single clickTag is always associated with a single VQL URL link, but the VQL URL link may goes through many different destinations. The system 1300 first maps clickTags to VQLs within the Engage Engine 302 (e.g., clickTag1=VQL1, clickTag2=VQL2, clickTag3=VQL3, etc.) At step 1324, the user answers questions or indicated preferences on the AdverGuide page 1310. At step 1326, the Engage Engine 302 the Engage Engine 1326 generates recommendations to select a consumer product item or set of items based on the visitor's preferences. The VQL system 1300, at step 1328, identifies and stores destination URL associated with the recommended consumer product. Once the destination URL has been stored, and the user has gone through the VQL system 1312 and accessed that destination, the clickTag is available to be associated with a new destination again. The destination URL is associated to a static clickTag on the AdverGuide 1310. At step 1330, the VQS system 1300 sends the associated clickTag and consumer product link to destination URL back to the AdverGuide 1310. At step 1332, the AdverGuide 1310 displays the recommended consumer product with link to the destination URL featuring the consumer product. At step 1334, the visitor clicks on the link requesting clickTag to redirect to the URL link. At step 1336, the Engage Engine 302 looks up the destination link and maps the clickTag to the link. As a result of the mapping at step 1322, clickTag3 is mapped to VQL3. At step 1338, the mapping to the destination link occurs, and VQL3 is subsequently mapped to whatever the destination is (in this case, URL Y, but for the next user this might be URL G). At step 1340, a browser is directed to the destination URL and the user sees the recommended consumer product website. It will be appreciated, the consumer product website associated with the destination URL link may be provided by the Engage Engine 302, or alternatively may be provided by a third-party service provider.

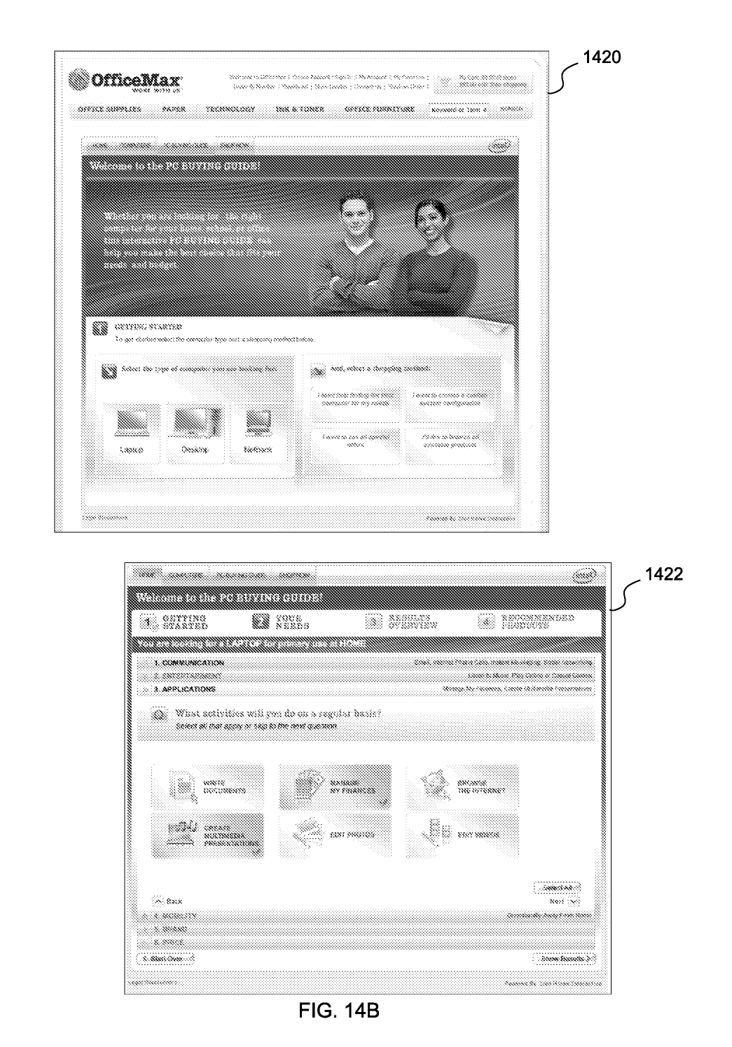

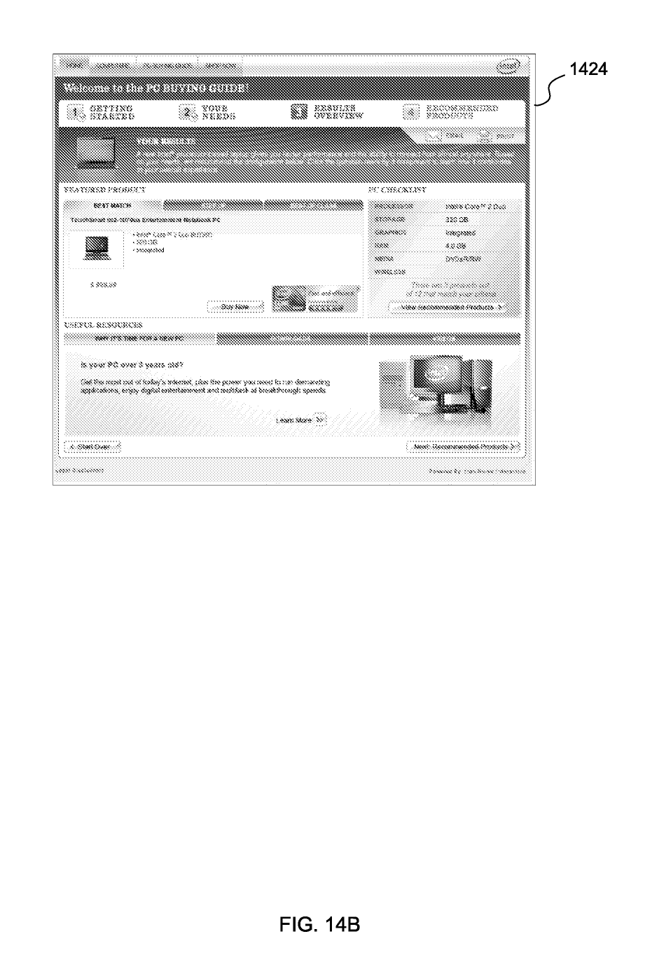

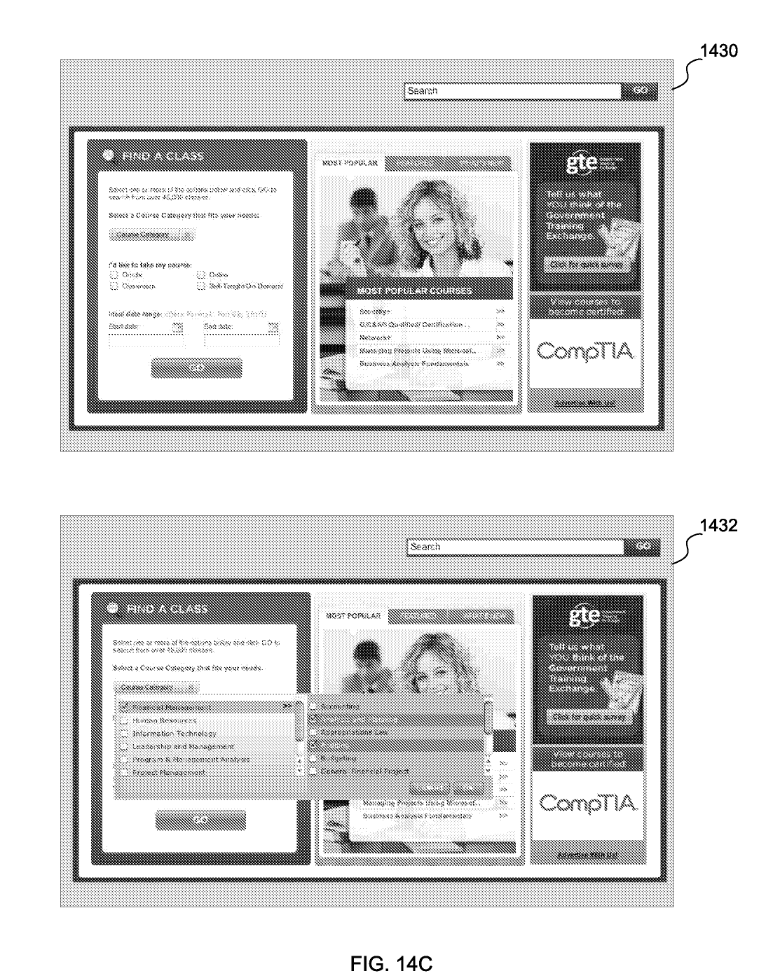

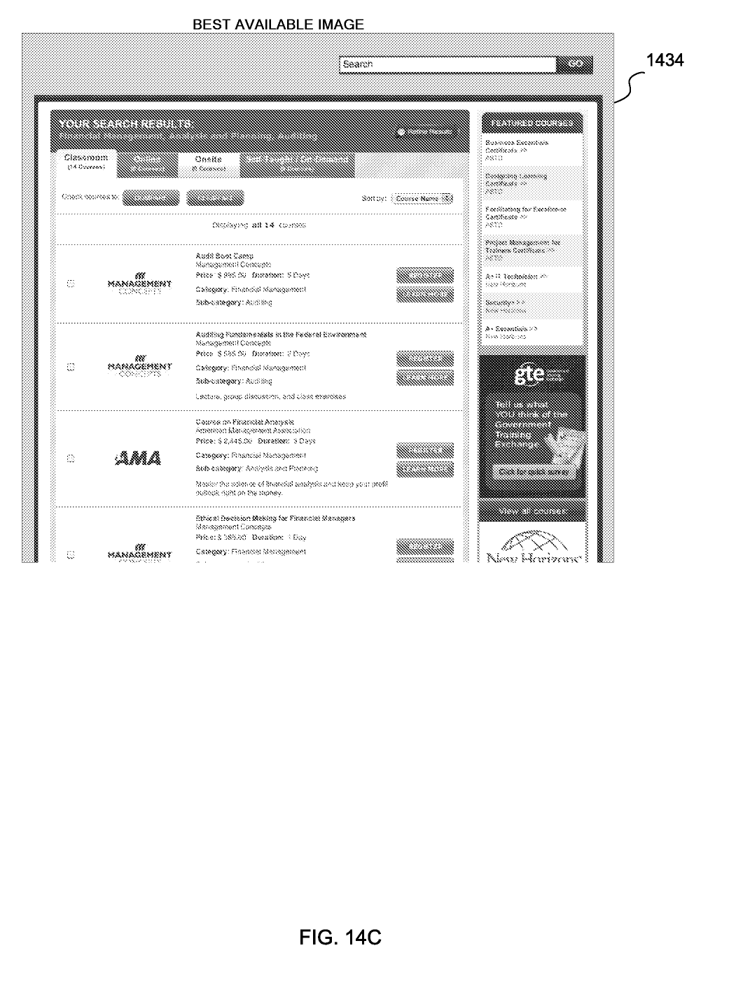

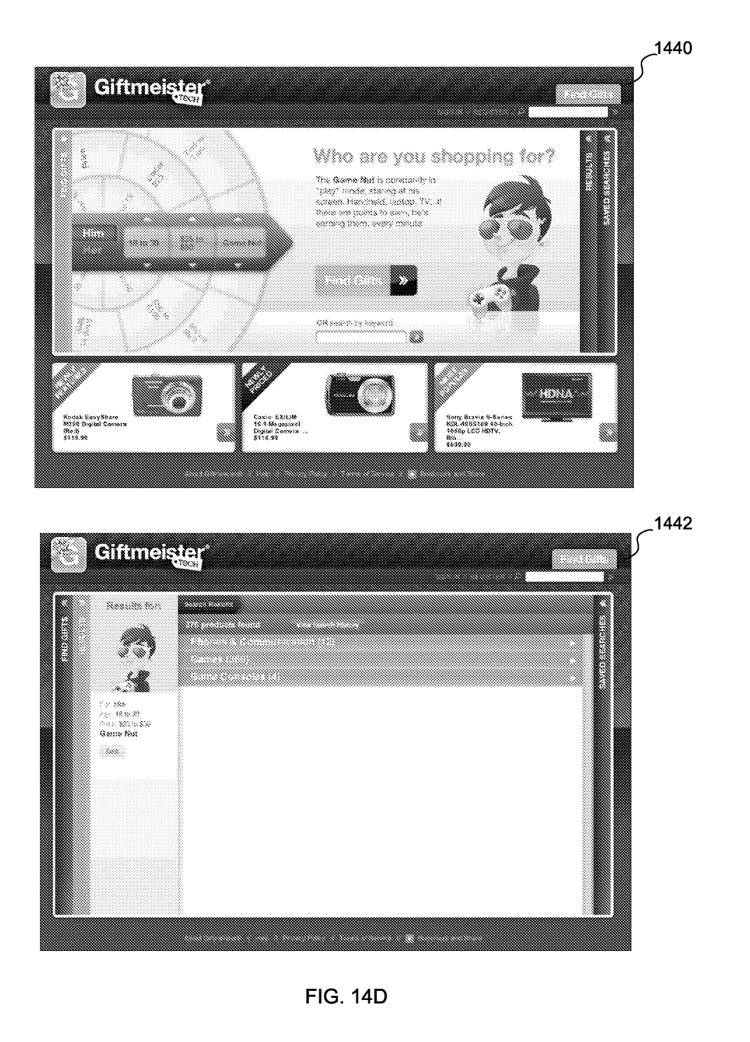

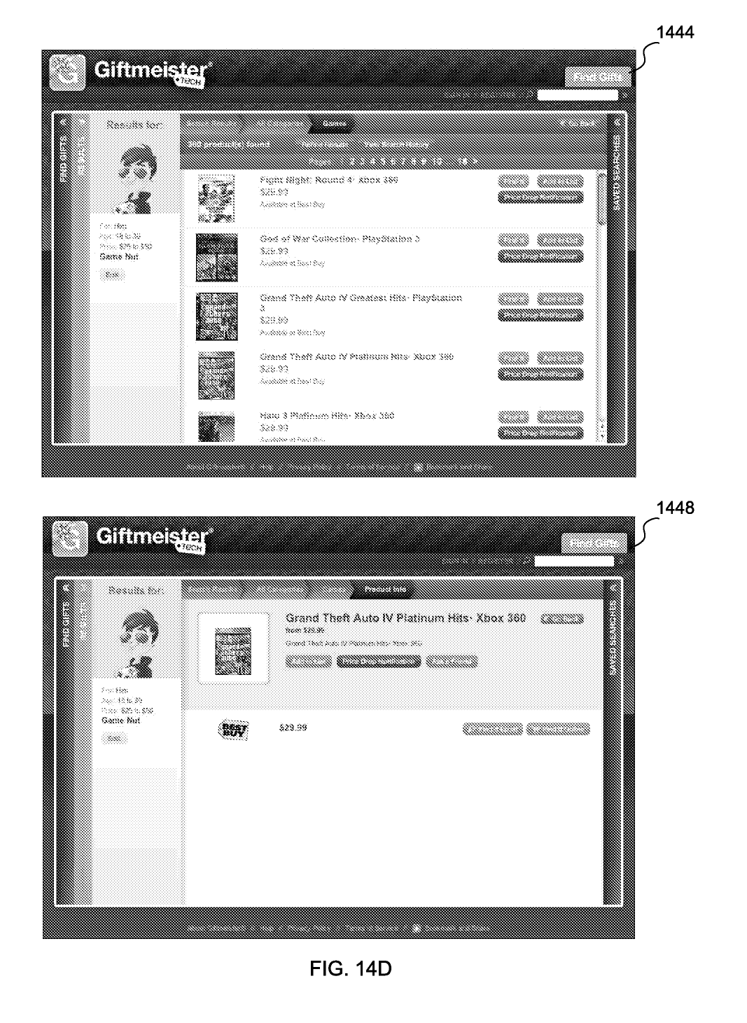

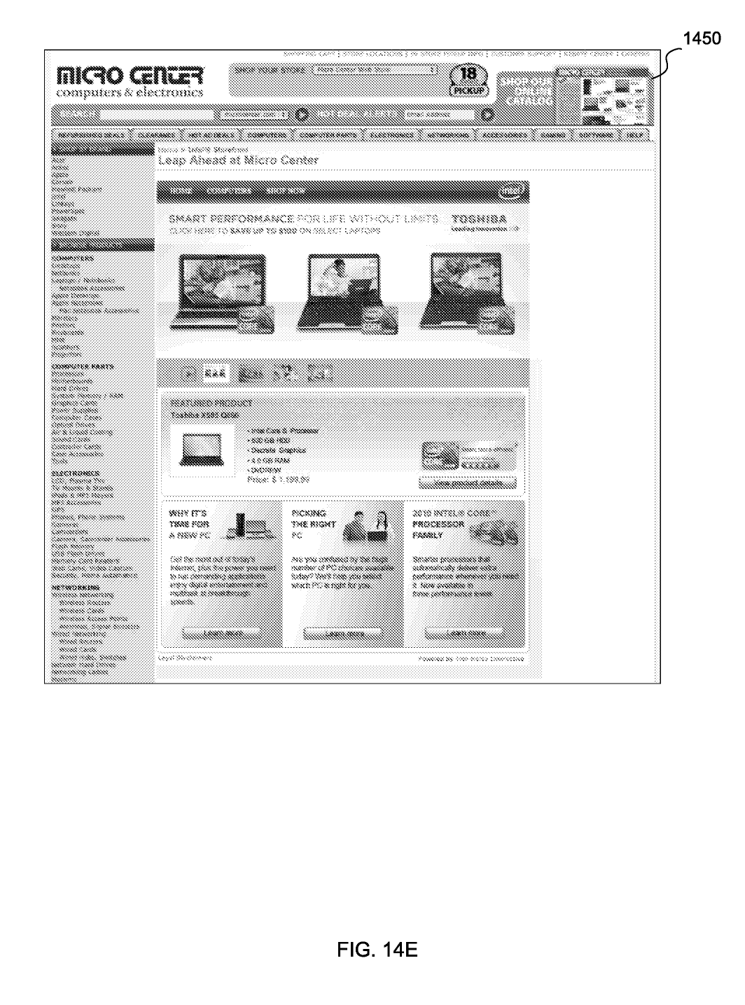

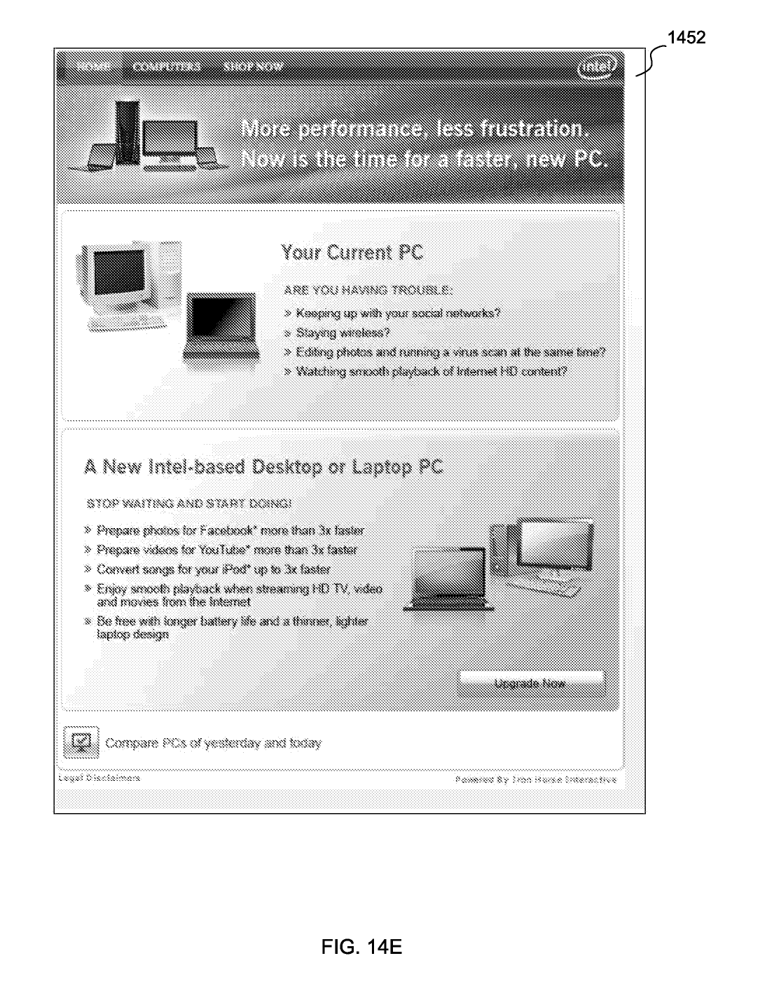

FIG. 14A are screenshot examples of the AdverGuide product 126 of FIG. 1, according to some embodiments. Like many other Engage Engine 302 based EE products, the AdverGuide is a dynamic ad unit, that can be constantly adjusted or updated, in real-time, for changing attributes such as prices, SKUs and offers, so it never becomes obsolete. The AdverGuide 126 is an interactive ad unit that allows consumers to answer questions about their consumer product needs, and in return recommends consumer products to them. The AdverGuide 126 is an eCommerce enabled, dynamic ad unit with built-in decision and recommendation features serviced by the Engage Engine 302. The AdverGuide 126 simplifies a visitors' decision process and provides the visitor with a consumer product recommendation within the ad, on the site they are already visiting. Thus, the AdverGuide 126 provides the ability to bring subscriber's store to the visitor, thereby increasing the likelihood of conversion. The AdverGuide 126 also allows for optimize methods provided through the Engage Engine 302 to provide real-time network analytics, and allows subscribers to access real-time, site-specific purchasing analytics across ad networks.

Screenshot 1410 illustrates a sample landing screen in which a visitor first views in an AdverGuide 126. In this example, the AdverGuide 126 prompts a visitor to provide preferences for a laptop computer from Dell. The visitor may click anywhere on the landing screen, or alternatively may be required to click a “getting started” icon. On the next screen, screenshot 1412, the visitor is prompted to answer questions based on product need, interests or other preferences. Based on the preferences and/or answers, the Engage Engine 302 generates one or more consumer product recommendations. Additional screenshots may be provided, further prompting the visitor to provide additional information. Screenshot 1414 is one example of providing consumer product recommendations based on a particular consumer product attribute, such as price. The AdverGuide 126 provides two consumer product recommendations in this case, one for a high-end laptop and one for a moderately priced laptop. The more expensive laptop is displayed in screenshot 1416 and the lower priced laptop is displayed in screenshot 1418, one of which will be provided when the visitor selects an option in screenshot 1414. Each consumer product selection 1416, 1418 may provide additional links providing more detail for each consumer product or make additional preferences on consumer product features and request additional recommendations. Although for illustration purposes the AdverGuide 126 utilizes Dell products exclusively, consumer products from multiple retailers may be featured. In this case Dell may be a subscriber, or alternatively may have been recommended based on visitor preferences.

FIGS. 14B and 14C are screenshot examples of the Buying Guide product 122 of FIG. 1, according to some embodiments. The Buying Guide 122 allows customer prospects to find the right consumer products and/or services for themselves, based on their specific needs. The Buying Guide 122 uses an easy-to-use, guided interface for assessing the consumer's requirements, and then providing consumer product recommendations. The Buying Guide 122 is a customizable, eCommerce-enabled consumer product finder and advisor that connects visitors with the products and services they need most. The Buying Guide 122 utilizes a dynamically updateable consumer product catalog to provide up-to-date pricing, inventory and product features and simplifies the visitor's decision process by offering multiple purchasing paths to generate a customized best fit consumer product or solution. The Buying Guide 122 provides marketers the ability to drive consumer product preference and increase both engagement and conversion, while providing insight into the visitor's purchasing decisions at the SKU-level and usage across the entire network. Subscribers can capture this intelligence, use it to see what their visitors most care about, and quickly optimize their marketing and sales strategies across channels accordingly. Content in the Buying Guide 122 can be optimized location-by-location to drive site-specific consumer product preferences.

The unique features of the Buying Guide 122 includes bringing the product catalog, recommendation functionality and showcase capability directly to where the prospective customer is, whether that be online, on a mobile device, or at an in-store kiosk. The use of the Buying Guide 122 reduces visitor frustration and research overload by delivering information in a purchasing style relevant to each visitor's needs.

Two examples, FIGS. 14B and 14C, are provided to illustrate the Buying Guide 122 features. FIG. 14B illustrates an example of a Buying Guide 122 directed to a consumer product. Screenshot 1420 is an example of a landing page to get a visitor started on the purchase of a desktop computer. On the landing page, the Buying Guide 122 may request information about the visitor's persona or type of shopper the visitor may be, and then determine how to interact with the visitor within varying degrees. For example, if the visitor selects “I need help . . . ” the Buying Guide will provide more guidance in assisting the visitor through the purchasing process. If the visitor selects “I want to see all special offers”, the Buying Guide 122 notes that the visitor may be price oriented and may accommodate the experience accordingly. Screenshot 1422 prompts the visitor through a series of questions and/or options to determine the visitor's preferences and consumer product needs. The visitor may be prompted through several windows or tabs. Screenshot 1424 displays based on the visitors preferences. In some embodiments, the Buying Guide 1422 may provide a single consumer product recommendation or a category of consumer product recommendations. For example, in screenshot 1424, three categories of consumer product recommendations are provided. The first features the best matched consumer products. The second featured consumer product is any product that falls in between the best match and the best in class product, both in terms of price as well as configuration. Another category may be the best of class which provides a high-end consumer product when price is not a factor. Alternatively, the visitor may be able to view all consumer products in the recommendation list by clicking “view recommended products.” It will be appreciated that any number of these features on the Buying Guide 122 windows may be enabled or disabled, and additional features are available to enable depending on the decision of the subscriber.

FIG. 14C illustrates examples of the Buying Guide 122 directed to a service consumer product, the Government Training Exchange. Screenshot 1430 is the landing page for a visitor to get started in selecting a training course. On the landing page, the visitor may select from a number of options from the Buying Guide 122 and decide how to get started. The visitor may provide preferences based on course category and type of course of interest (e.g., onsite, classroom, online, and so on). Alternatively, the visitor may select from a list of most popular courses. In screenshot 1432, the visitor is prompted to provide additional preference information. The Buying Guide 122 then provides a recommended course or list of courses in screenshot 1434. Again, all features in this Buying Guide example are configurable by the subscriber.

FIG. 14D are screenshot examples of the Giftmeister product 120 of FIG. 1, according to some embodiments. The Giftmeister 120 allows customer prospects to find gifts for themselves or for others, and create shopping lists or wish lists to share with friends and family. The Giftmeister 120 is a unique, turnkey gifting engine that helps customer prospects find, buy and gift consumer products in a simple and personalized way. The subscriber is provided with new access to large and growing market segments, optimizes engagement, and provides insight across the sales network about how customer prospects interact with messaging and consumer products. The Giftmeister 120 provides visitors the ability to search, price comparison shop, and receive alerts via SMS and email.

Similar to the AdverGuide 126, the Giftmeister 120 starts with a landing page as screenshot 1440. On the landing page, the visitor may selection from several categories of preferences. In this case, the visitor is prompted to select the age-group, the price-range, and persona of the gift-recipient. Based on the initial preferences provided, the Giftmeister generates a recommended set of gifts on screenshot 1442 organized in tabs by category or consumer product-type. Upon selection of one of the tabs a list of the recommended consumer products in that category are provided in screenshot 1444. Each of the recommended consumer product items may also be selected to display addition information about the item and provide additional options for the visitor, as shown on screenshot 1448. For the selected item to view, the visitor may add the item to a selectable set of lists such as add to a “my friend list” or “my list”. The lists may be created by the visitor or pre-generated by the decision of the subscriber. The visitor may additionally request a price drop notification or email the selected item to a friend. It will be appreciated that additional features are not shown but may be provided in a similar manner.

FIG. 14E are screenshot examples of the Showcase 124 of FIG. 1, according to some embodiments. The Showcase 124 provides informative content and resources for various consumer products and their features, facilitating customer prospects to make informed purchasing decisions. The Showcase 124 is a customizable eCommerce-enabled brand showcase that is integrated with a dynamically updateable consumer product/content catalog and is embedded anywhere the visitor is. Showcase 124 provides subscribers the ability to drive consumer product preference by allowing them to deliver relevant content across their entire advertising network. From the visitor's perspective, Showcase 124 represents a self-guided experience to explore the brand's offerings and influences visitors' decision process. Behind the scenes, the Showcase 124 collects intelligence about visitors and can be configured to emphasize relevant content depending on the origin of the visitor.

The Showcase 124 also enables subscribers to optimize their product influence. Data collected by the Showcase 124 allows for the analysis of daily statistics from across sales network and revise messaging, relevant content, offers and showcased consumer products for each online location.

Screenshot 1450 is an example of a subscriber, Micro Center, to “showcase” their consumer products and services. The subscriber may customize the content and the organization of the content on their showcase window. All of the content may be configurable, replaceable and updatable at any time. The showcase window may additionally include links which visitors may select to go to another window featuring a specific consumer product or to other third party sites featuring a particular consumer product, as shown in screenshot 1452.

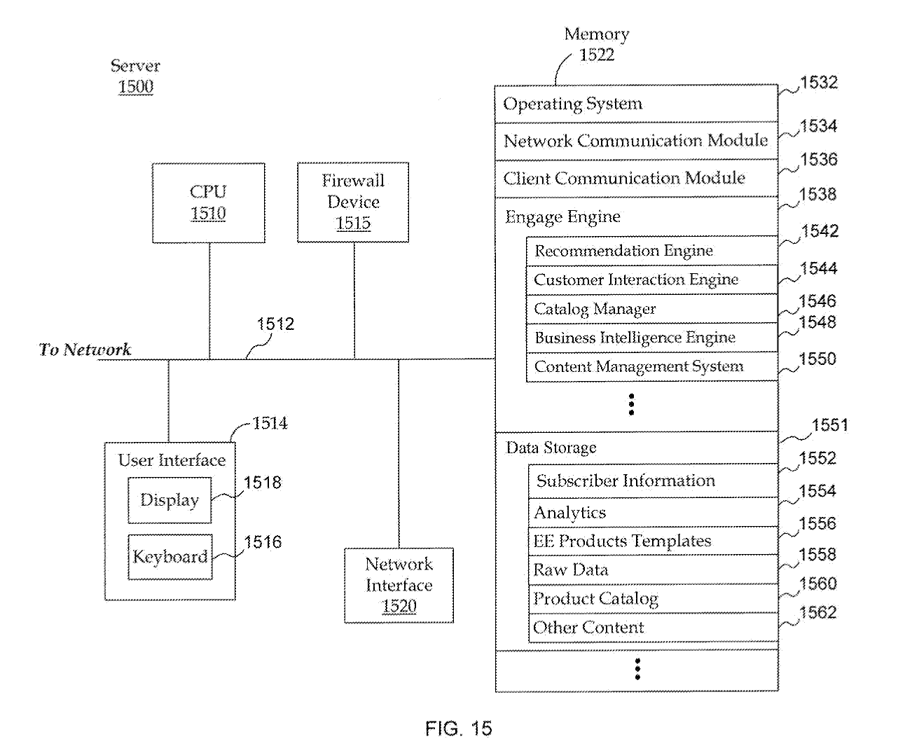

FIG. 15 is a block diagram illustrating an embodiment of a server system 1500 according to embodiments. The server system 1500 represents a single server for illustration purposes; however, it will be appreciated that the features described with respect to server system 1500 may be configurable, in parts or in its entirety, across multiple server systems, machines and devices. The server system 1500 may include at least one data processor or central processing unit (CPU) 1510, one or more optional user interfaces 1514, a communications or network interface 1520 for communicating with other computers, servers and/or clients, a memory 1522 and one or more signal lines 1512 for coupling these components to one another. The user interface 1514 may have a keyboard/mouse 1516 and/or a display 1518. The one or more signal lines 1512 may constitute one or more communications busses, and may connect to a network.

The server system 1500 may additionally include a firewall device 1515 to provide a secured system that prevents unauthorized access to the applications and data accessed from memory 1522. In some embodiments, the firewall 1515 is placed between the network and server system 1500 to protect from any unauthorized entry points. In some embodiments, the firewall is a software application (not shown), or an additional application to the firewall device 1515, that is executed from memory 1522 by the CPU 1510.

The memory 1522 may include high-speed random access memory and/or non-volatile memory, such as one or more magnetic disk storage devices. The memory 1522 may store an operating system 1532, such as LINUX, UNIX or WINDOWS, that includes procedures for handling basic system services and for performing hardware dependent tasks. The memory 1522 may also store communication procedures in a network communication module 1534. The communication procedures are used for communicating with clients, such as the clients 208 (FIG. 2), and with other servers and computers.

The memory 1522 may include components and applications of an Engage Engine 1538, comprising of at least a recommendation engine 1542, customer interaction engine 1544, catalog manager 1546, business intelligence engine 1548, and content management system 1550. These components of the Engage Engine 1538 have been described in detail and operate in the same manner as described in previous sections of this patent document.

Memory 1522 also includes data storage 1551 to store data accessed and managed by the Engage Engine 1538 or applications at other servers and machines. Stored data includes subscriber information 1552, analytics 1554, EE products templates 1556, raw data 1558, and product catalogs 1560. The data stored in data storage 1551 is accessed by the various components of the Engage Engine 1538 in accordance with previous described embodiments. Data storage 1551 additionally includes other content 1562, which may include other data from subscribers or other permitted users that are relevant to the service operations of the Engage Engine 1558.

It will be appreciated that the Engage Engine 1558 is comprised of various applications (software) and storage features that run on arrays of physical servers in various configurations, one of which is illustrated by the server system 1500.

FIG. 15 is intended more as a functional description of the various features which may be present in a distributed database system rather than as a structural schematic of the embodiments described herein. In practice, and as recognized by those of ordinary skill in the art, the functions of the server 1500 may be distributed over a large number of servers or computers, with various groups of the servers performing particular subsets of those functions. Items shown separately in FIG. 15 could be combined and some items could be separated. For example, some items shown separately in FIG. 15 could be implemented on single servers and single items could be implemented by one or more servers. The actual number of servers in the Engage Engine system 302 of FIG. 3 and how features are allocated among them will vary from one implementation to another, and may depend in part on the number and types of applications, and the amount of information stored by the system 1500.

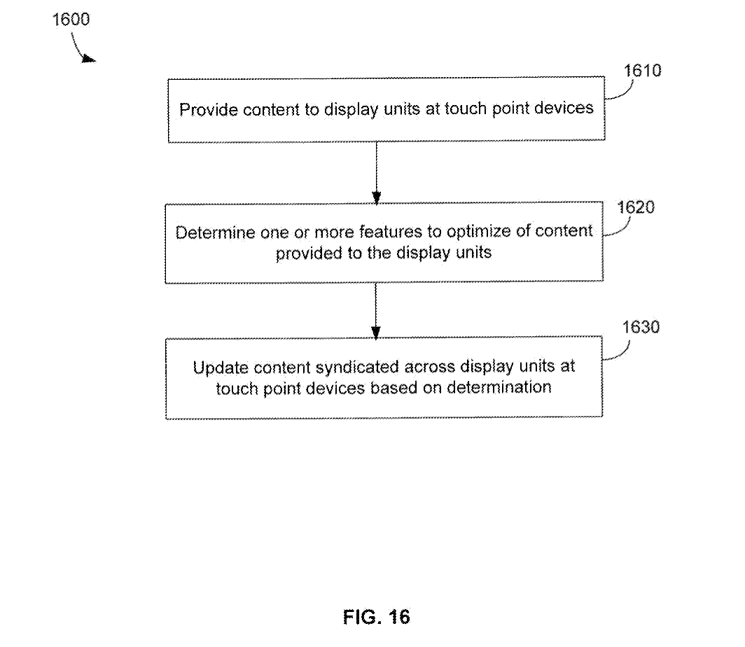

FIG. 16 is a flow diagram of a method of providing content by a decision engine system, according to some embodiments. On a server system having one or more processors and memory storing programs to be executed by the one or more processors, at step 1610, content is provided to a plurality of display units at a plurality of touch point devices, wherein the content is stored in the server system. At step 1620, one or more features to optimize are determined of the content provided to the plurality of display units. At step 1630, the content is updated syndicated across the plurality of display units at the plurality of touch point devices based on the determination.

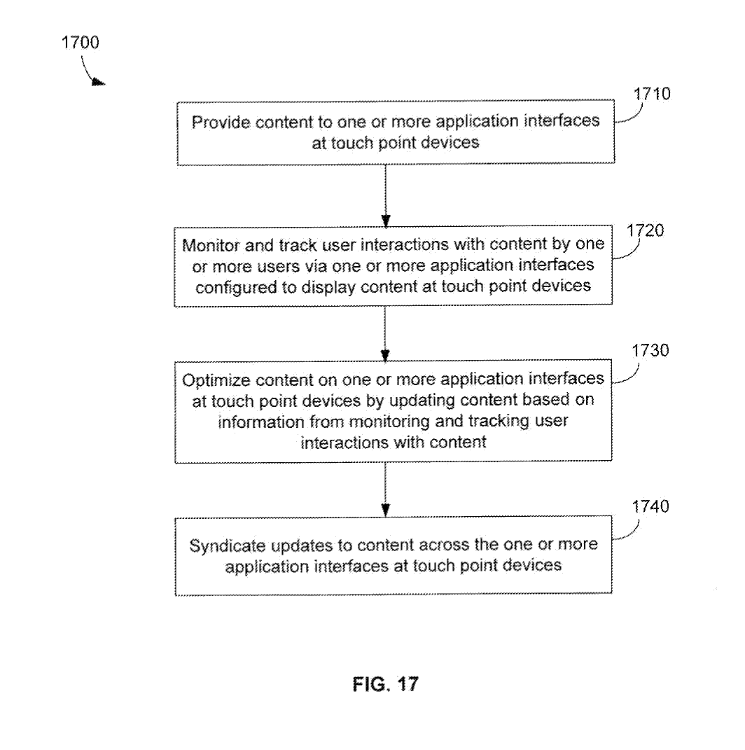

FIG. 17 is a flow diagram of a method of providing content by a decision engine system, according to some other embodiments. On a server system having one or more processors and memory storing programs to be executed by the one or more processors, at step 1710, content is provided to one or more application interfaces at a plurality of touch point devices, wherein the content is stored in the server system. User interactions are tracked and monitored, at step 1720, with the content by one or more users via one or more application interfaces configured to display the content at the plurality of touch point devices. At step 1730 the content on one or more application interfaces at the plurality of touch point devices is optimized by updating the displayed content based on information from monitoring and tracking user interactions with content. At step 1740, updates to the content are syndicated across the one or more application interfaces at the plurality of touch point devices.

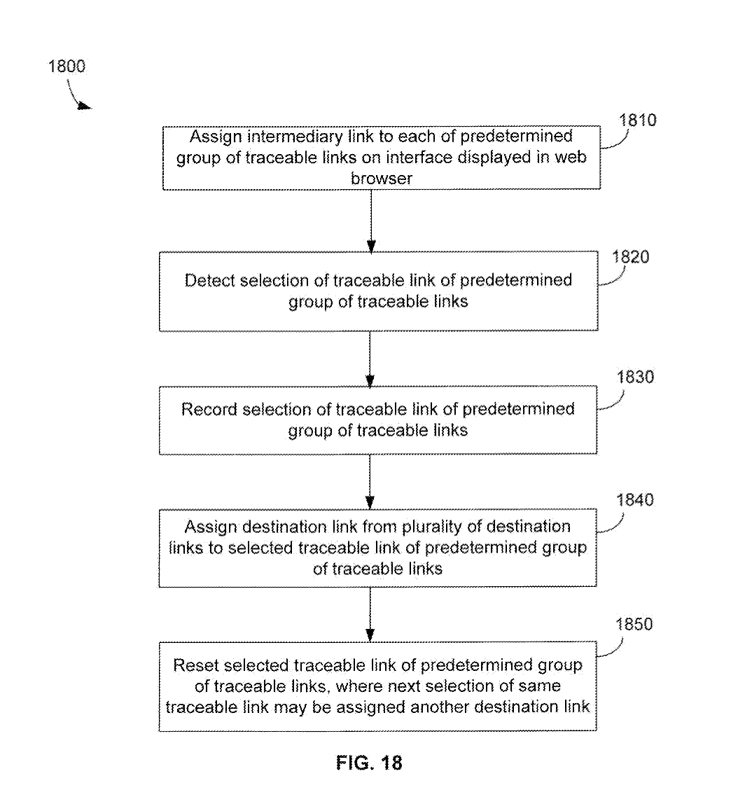

FIG. 18 is a flow diagram of a method for a virtualized queuing process of traceable links, according to some embodiments. On a server system having one or more processors and memory storing programs to be executed by the one or more processors, at step 1810, an intermediary link is assigned to each of a predetermined group of traceable links on a website displayed in a web browser. At step 1820, a selection of a traceable link of the predetermined group of traceable links is detected. At step 1830, the selection of the traceable link of the predetermined group of traceable links is recorded. At 1840, a destination link is assigned from a plurality of destination links to the selected traceable link of the predetermined group of traceable links. At 1850, the selected traceable link of the predetermined group of traceable links is reset, where the resetting provides a next selection of the traceable link of the predetermined group of traceable links to assign another destination link to the same traceable link.

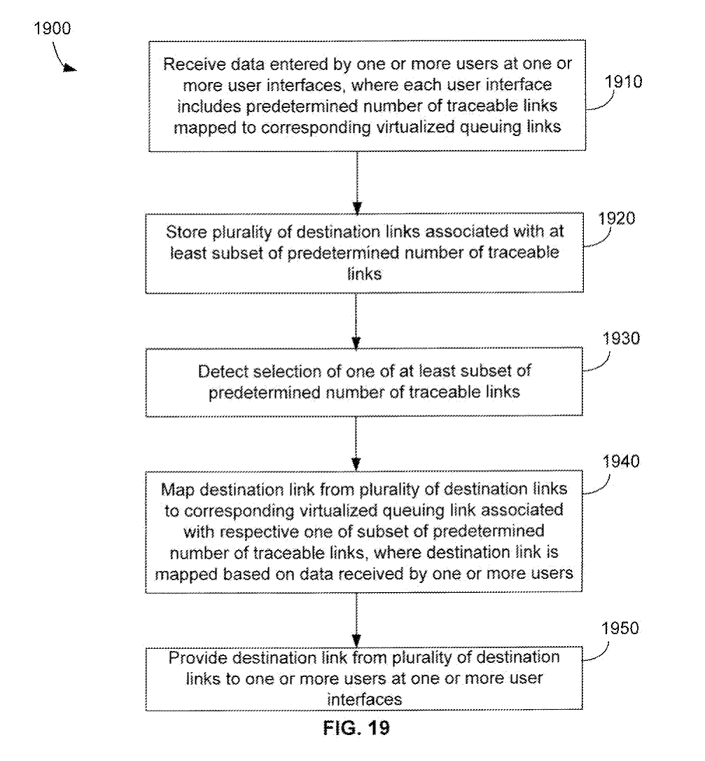

FIG. 19 is a flow diagram of a method for a virtualized queuing process of traceable links, according to some other embodiments. On a server system having one or more processors and memory storing programs to be executed by the one or more processors, at step 1910, data is received entered by one or more users at one or more user interfaces, where each of the one or more user interfaces include a predetermined number of traceable links mapped to corresponding virtualized queuing links. At step 1920, a plurality of destination links associated with the at least a subset of the predetermined number of traceable links are stored. At 1930 selection of one of the at least a subset of the predetermined number of traceable links is detected. At 1940, a destination link is mapped from the plurality of destination links to the corresponding virtualized queuing link associated with the respective one of the at least a subset of the predetermined number of traceable links, wherein the destination link is mapped based on the data received by the one or more users. At step 1950, the destination link is provided from the plurality of destination links to the one or more users at the one or more user interfaces.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of providing content by a decision engine system, comprising:
on a server system having one or more processors and memory storing programs to be executed by the one or more processors:
providing content to a plurality of display units at a plurality of touch point devices, wherein the content is stored in the server system;
determining one or more features to optimize of the content provided to the plurality of display units; and
updating the content syndicated across the plurality of display units at the plurality of touch point devices based on the determination.

2. The computer-implemented method of claim 1, wherein determining one or more features to optimize of the content provided to the plurality of display units comprise:
receiving data from a user prospect interacting with the content on one of the plurality of touch point devices; and
updating content based on one or more recommendations provided based on the received data from the user prospect.

3. The computer-implemented method of claim 1, further comprising:
receiving data from a user prospect interacting with the content provided to one of the plurality of touch point devices;
applying the data received from the user prospect to one or more rules; and
including an update to the content provided to the user prospect based on applying the data received from the user prospect to one or more rules when updating the content syndicated across the plurality of display units at the plurality of touch point devices.

4. The computer-implemented method of claim 3, wherein including an update to the content provided to the user prospect includes generating a recommendation of content based on applying the data to the one or more rules.

5. The computer-implemented method of claim 4, wherein the one or more rules includes a subset of a group consisting of:
relevancy of content to user prospect interaction with the content provided,
relevancy to user prospect profile information,
availability of new and updated content, and
pre-existing user data.

6. The computer-implemented method of claim 1, wherein updating the content syndicated across the plurality of display units at the plurality of touch point devices includes updating the content at each of the plurality of display units independent of each other.

7. The computer-implemented method of claim 1, wherein updating the content syndicated across the plurality of display units at the plurality of touch point devices is executed at a centralized location in the server system.

8. The computer-implemented method of claim 1, wherein the content provided is derived from content that is stored in the server system and dynamically updated in an automated manner.

9. The computer-implemented method of claim 1, further comprising conducting a performance check on each of the content provided by applying one or more performance check parameters on the content being provided.

10. The computer-implemented method of claim 9, wherein applying one or more performance check parameters on the content being provided include determining whether the content is within a threshold value of an acceptable parameter; and updating the content if it has not met the threshold value.

11. A decision engine system, comprising:
a plurality of interfaces configured to provide content at a plurality of touch point sites;
a dynamically updating catalog configured to store the content displayed at the plurality of touch points sites, wherein the dynamically updating catalog is updated from information gathered from a plurality of data sources in a recurrent and consistent manner; and
a decision engine associated with the dynamically updating catalog and configured to manage and optimize the content provided to the plurality of interfaces from a centralized location, wherein the centralized decision engine syndicates the managing and optimizing of one or more content across the plurality of interfaces.

12. The computer-implemented method of claim 11, wherein the decision engine configured to manage and optimize the content is further configured to receive data from a user prospect interacting with the content on one of the plurality of interfaces and update the content based on one or more recommendations provided based on the received data from the user prospect.

13. The system of claim 11, wherein the plurality of data sources comprise a subset from a group consisting of: a plurality of websites, one or more data feeds, data files created in applications over private networks, data files created in application over private networks, and data that is manually entered.

14. The system of claim 11, wherein the information gathered from a plurality of data sources comprise processing the information gathered to cleanse, consolidate and validate the information gathered.

15. The system of claim 11, wherein optimize the content comprises the centralized decision engine being configured to learn about one or more users at one or more of the plurality of interfaces based on the one or more users' interactions with content and updating the content based on the one or more users' interactions while syndicating updates to one or more content across the plurality of interfaces.

16. The system of claim 11, wherein optimize the content comprises the centralized decision engine being configured to track the actions and decisions of users interacting with content at the plurality of interfaces and creates analytics of such interactions.

17. A computer-implemented method of providing content by a decision engine system, comprising:
on a server system having one or more processors and memory storing programs to be executed by the one or more processors:
providing content to one or more application interfaces at a plurality of touch point devices, wherein the content is stored in the server system;
monitoring and tracking user interactions with content by one or more users via one or more application interfaces configured to display the content at the plurality of touch point devices;
optimizing the content on one or more application interfaces at the plurality of touch point devices by updating the displayed content based on information from monitoring and tracking user interactions with content, wherein optimizing the displayed content includes syndicating updates to the content across the one or more application interfaces at the plurality of touch point devices.

18. The computer-implemented method of claim 17, wherein optimizing the content on one or more application interfaces comprises:
receiving data from a user prospect interacting with the content on one or more application interfaces at the plurality of touch point devices; and
updating the content based on one or more recommendations provided by the server system based on the received data from the user prospect.

19. The computer-implemented method of claim 17, further comprising
crawling data sources for new and updated content at intervals of a predetermined time period;
collecting and storing the new and updated content data from the tracking of user interactions and crawling of data sources across a plurality of websites; and
optimizing the content on one or more application interfaces at the plurality of touch point devices by updating the content based on collected and stored new and updated content, wherein optimizing the content includes syndicating updates to the content across the one or more application interfaces at the plurality of touch point devices.

20. The computer-implemented method of claim 17, further comprising
receiving data from one or more users interacting with the content;
applying the data received from the one or more users to one or more rules; and
recommending content for the one or more users at least based on applying the data received from one or more users to the one or more rules, wherein the recommended content is provided while syndicating updates to content across the one or more application interfaces at the plurality of touch point devices.

21. The computer-implemented method of claim 17, wherein the one or more rules include a subset of a group consisting of:
relevancy of content to interaction with the displayed content by the one or more users,
relevancy to one or more user profile information,
availability of new and updated content, and
pre-existing user data.

22. The computer-implemented method of claim 17, wherein optimizing the content includes updating the content syndicated across the one or more application interfaces at the plurality of touch point devices independent of each other.

23. The computer-implemented method of claim 15, wherein updating the content syndicated across the one or more application interfaces is executed at a centralized location in the server system.

24. A computer-implemented method for a virtualized queuing process of traceable links, comprising:
on a server system having one or more processors and memory storing programs to be executed by the one or more processors:
assigning an intermediary link to each of a predetermined group of traceable links on an interface displayed in a web browser;
detecting a selection of a traceable link of the predetermined group of traceable links;
recording the selection of the traceable link of the predetermined group of traceable links;
assigning a destination link from a plurality of destination links to the selected traceable link of the predetermined group of traceable links; and
resetting the selected traceable link of the predetermined group of traceable links, wherein the resetting provides a next selection of the traceable link of the predetermined group of traceable links to assign another destination link to the same traceable link.

25. The computer-implemented method of claim 24, wherein the predetermined group of traceable links are statically associated with each respective intermediary link, and each of the intermediary links associated with the respective predetermined group of traceable links are dynamically associated with the plurality of destination links.

26. The computer-implemented method of claim 24, wherein the predetermined group of traceable links are provided by at least one third party server.

27. The computer-implemented method of claim 24, wherein the plurality of destination links are mapped to a plurality of URL locations over a network by the server system.

28. The computer-implemented method of claim 24, wherein the next selection of the traceable link comprises replacing the assigned destination link with another destination link from the plurality of destination links after the assigned destination link has been asserted.

29. The computer-implemented method of claim 24, wherein the plurality of destination links comprise URL locations to consumer product websites over a network.

30. A computer-implemented method for a virtualized queuing process of traceable links, comprising:
on a server system having one or more processors and memory storing programs to be executed by the one or more processors:
receiving data entered by one or more users at one or more user interfaces, wherein each of the one or more user interfaces include a predetermined number of traceable links mapped to corresponding virtualized queuing links;
storing a plurality of destination links associated with the at least a subset of the predetermined number of traceable links;
detecting a selection of one of the at least a subset of the predetermined number of traceable links;
mapping a destination link from the plurality of destination links to the corresponding virtualized queuing link associated with the respective one of the at least a subset of the predetermined number of traceable links, wherein the destination link is mapped based on the data received by the one or more users; and
providing the destination link from the plurality of destination links to the one or more users at the one or more user interfaces.

31. The computer-implemented method of claim 30, further comprising:
generating one or more recommendations of content based on the received data entered by the one or more users; and
displaying the one or more recommendations of content at the one or more user interfaces, wherein the one or more recommendations of content includes the at least a subset of the predetermined number of traceable links.

32. The computer-implemented method of claim 30, wherein the predetermined number of traceable links are statically associated with each respective virtualized queuing link, and each of the virtualized queuing links associated with the respective predetermined number of traceable links are dynamically associated with the plurality of destination links.

33. The computer-implemented method of claim 30, wherein the predetermined number of traceable links are provided by at least one third party server.

34. The computer-implemented method of claim 30, wherein the plurality of destination links is mapped to a plurality of URL locations over a network by the server system.

35. The computer-implemented method of claim 30, further comprises replacing the mapped destination link with another destination link from the plurality of destination links after the mapped destination link has been provided to the one or more users.

36. The computer-implemented method of claim 30, wherein the plurality of destination links comprises URL locations to consumer product websites over a network.

37. A server system, comprising:
a product interface configured to include a predetermined number of traceable links;
a corresponding number of virtualized queuing links, each virtualized queuing link associated with each traceable link of the predetermined number of traceable links;
a storage component configured to store locations of a plurality of destination links and the corresponding number of virtualized queuing links associated with each traceable link of the predetermined number of traceable links;
a decision engine component configured to service the product interface, and, in response to receiving preference data from a user via the product interface, associates a subset of the plurality of destination links to the corresponding number of virtualized queuing links, wherein the decision engine provides a destination link from the subset of the plurality of destination links to the user upon selection of a traceable link.

38. The system of claim 37, wherein the predetermined number of traceable links are statically associated with each respective virtualized queuing link, and each of the virtualized queuing links associated with the respective predetermined number of traceable links are dynamically associated with the plurality of destination links.

39. The system of claim 37, wherein the predetermined number of traceable links are provided by at least one third party server.

40. The system of claim 37, wherein the plurality of destination links are mapped to a plurality of URL locations over a network by the decision engine system.

41. The system of claim 37, wherein the decision engine resets the associated virtualization queuing link after the destination link from the subset of the plurality of destination links is displayed to the user upon selection of the traceable link and provides for another destination link upon a next selection of the traceable link.

42. The system of claim 37, wherein the plurality of destination links comprises URL locations to consumer product websites over a network.
